(19) United States
(12) Patent Application Publication
(10) Pub. No.: US 2021/0134257 A1
(43) Pub. Date: May 6, 2021

(54) MATERIAL, ACOUSTIC BARRIER ASSEMBLY CONSTRUCTED FROM THE MATERIAL, AND METHOD FOR ASSEMBLING THE ACOUSTIC BARRIER ASSEMBLY

(71) Applicant: Gulfstream Aerospace Corporation, Savannah, GA (US)

(72) Inventor: Nicholas Yovich, Savannah, GA (US)

(73) Assignee: Gulfstream Aerospace Corporation, Savannah, GA (US)

(21) Appl. No.: 16/669,762

(22) Filed: Oct. 31, 2019

(51) Int. Cl. G10K 11/168; B32B 7/022; B32B 7/12; B32B 9/00; B32B 3/26; B32B 37/12; B32B 37/00

(52) U.S. Cl. CPC G10K 11/168; B32B 7/022; B32B 7/12; B32B 9/007; B32B 3/26; B32B 2038/0052; B32B 37/0076; B32B 2307/102; B32B 2307/7242; B32B 2307/546; B32B 2307/558; B32B 37/12

(57) ABSTRACT

A material for use in construction of an acoustic barrier assembly is disclosed herein. The material includes, but is not limited to, a first layer comprised of a first flexible material. The first flexible material is configured to be impermeable to a lightweight gas. The material further includes, but is not limited to, a second layer coupled with the first layer. The second layer is comprised of a second flexible material. The second flexible material has less flexibility than the first flexible material.

### TECHNICAL FIELD

The present invention relates generally to noise suppression and more particularly relates to a material suitable for use in the construction of an acoustic barrier assembly, an acoustic barrier assembly constructed with the material, and a method of assembling an acoustic barrier assembly including the material.

### BACKGROUND

It is desirable to obstruct and/or impede the transmission of sound from one location to another onboard a vehicle. For example, it is desirable to inhibit the sounds of the freestream air flowing over an exterior portion of an aircraft from entering the cabin of the aircraft. In another example, it is desirable to prevent sounds in one compartment of an aircraft from passing through a bulkhead and/or a door and entering into another compartment of the aircraft.

One solution entails the positioning of a mass between compartments or between adjacent locations to provide sound insulation. This approach is currently employed in many aircraft applications. A single wall mass barrier material is placed between the sound source and the desired quiet receiver space, for example. A drawback of using a single wall mass barrier to inhibit the transmission of sound is that, in some applications, in order to obtain desirable levels of sound insulation, substantial amounts of mass must be used. This is undesirable in vehicle applications because increasing the mass of the vehicle can adversely impact the performance of the vehicle.

Another solution entails separating compartments or adjacent locations with a double walled barrier. The double wall barrier includes two masses (e.g., two walls) that are separated by a cavity filled with air. This solution is generally superior to the mass solution stated above, but the presence of air in the cavity acts as a medium for the transmission of sound between the two masses. Accordingly, this solution still permits more sound to pass from one location to another than is desired.

Another solution entails separating compartments or adjacent locations with a double wall barrier having a cavity disposed between the two walls and a vacuum within the cavity. This solution is superior to the double walled solution discussed above because the absence of any matter between the two walls inhibits the transmission of any sound energy from one wall to the other. However, the long-term maintenance of a vacuum poses a challenge. When the vacuum fails, this solution provides no greater sound isolation than the solution discussed above. Furthermore, in order to maintain a vacuum between the two walls, a rigid, robust structure must be employed to support the two walls in a spaced apart relationship. The rigidity of the structure may substantially limit the locations where it may be employed. Additionally, because of the strength and robust nature of the materials used in the support frame that connects the two walls, the frame itself may transmit vibration from the acoustically or vibrationally excited source wall to the receiver wall that will then radiate sound to the receiver space. The rigid structure connecting the two walls can become a vibration flanking path.

Another solution is to use an acoustic barrier assembly utilizing a lighter-than-air gas insulator. In an embodiment, an acoustic barrier assembly comprises a flexible container defining a fluid-tight pocket in which a lighter-than-air gas is housed. The lighter-than-air gas serves as an excellent sound barrier.

However, if the acoustic barrier assembly is constructed from a flexible material or fabric, then there is a risk that the lighter-than-air gas may escape. For example, helium is a lighter-than-air gas that is comprised of extremely small molecules. For this reason, helium is extremely difficult to contain using flexible materials. Apart from using some metals to contain helium, conventionally there has been no way to store helium in a gaseous state for lengthy periods of time without experiencing substantial losses of the helium. This is undesirable.

Accordingly, it is desirable to provide a material that is both flexible and impermeable to helium. In addition, it is desirable to provide an acoustic barrier assembly that is constructed of a material that is impermeable to helium. It is further desirable to provide a method for assembling an acoustic barrier assembly using a material that is impermeable to helium. Furthermore, other desirable features and characteristics will become apparent from the subsequent summary and detailed description and the appended claims, taken in conjunction with the accompanying drawings and the foregoing technical field and background.

### BRIEF SUMMARY

A material for use in the construction of an acoustic barrier assembly, an acoustic barrier assembly made with the material, and a method of assembling the acoustic barrier assembly are disclosed herein.

In a first, non-limiting embodiment, the material includes, but is not limited to, a first layer comprising a first flexible material. The first flexible material is configured to be impermeable to a lighter-than-air gas. The material further includes, but is not limited to, a second layer coupled with the first layer, the second layer comprising a second flexible material. The second flexible material has less flexibility than the first flexible material.

In another non-limiting embodiment, the acoustic barrier assembly includes, but is not limited to, a first wall formed of a material. The acoustic barrier assembly further includes a second wall formed of the material. The second wall is coupled with the first wall. The first wall and the second wall cooperate to form a pocket. The acoustic barrier assembly still further includes, but is not limited to, a lighter-than-air gas contained within the pocket. The material includes, but is not limited to, a first layer comprising a first flexible material. The first flexible material is configured to be impermeable to the lighter-than-air gas. The material further includes a second layer coupled with the first layer, the second layer comprising a second flexible material. The second flexible material has less flexibility than the first flexible material.

In another non-limiting embodiment, the method includes, but is not limited to the steps of obtaining a plurality of sheets of a material. The material includes, but not limited to, a first layer comprising a first flexible material. The first flexible material is configured to be impermeable to a lighter-than-air gas. The material further includes, but is not limited to, a second layer that is coupled with the first layer. The second layer comprises a second flexible material having less flexibility than the first layer. The material further includes, but is not limited to, a third layer coupled to one of the first layer and the second layer. The third layer comprises a third flexible material and further comprises an adhesive. The method further includes, but is not limited to, the step of coupling the plurality of sheets of material together proximate a respective periphery of each sheet of material in a manner that forms a fluid-tight pocket and that leaves a portion of the plurality of sheets of material uncoupled to form an opening. Each sheet of material is coupled together with each neighboring sheet of material via the third layer of each respective sheet. The method further includes, but is not limited to, the step of inflating the acoustic barrier assembly by passing gas through the opening into the pocket. The method still further includes, but is not limited to, sealing the opening to retain the gas within the pocket.

### BRIEF DESCRIPTION OF THE DRAWINGS

The present invention will hereinafter be described in conjunction with the following drawing figures, wherein like numerals denote like elements, and

FIG. 1 is a fragmentary schematic cross-sectional view of an aircraft suitable for use with embodiments of an acoustic barrier assembly of the present disclosure;

FIG. 2 is a schematic fragmentary cross-sectional view of an exemplary dividing structure (such as a wall, floor, door, fuselage, etc.) of the aircraft of FIG. 1 suitable for housing the acoustic barrier assembly of the present disclosure;

FIG. 3 is a perspective view illustrating a non-limiting embodiment of the acoustic barrier assembly of the present disclosure;

FIG. 4A is a schematic cross-sectional view of a non-limiting embodiment of an acoustic barrier assembly of the present disclosure;

FIGS. 4B-C are schematic cross-sectional views of alternate embodiments of the acoustic barrier assembly illustrated in FIG. 4A;

FIG. 5 is a schematic cross-sectional view of an alternate, non-limiting embodiment of an acoustic barrier assembly of the present disclosure;

FIG. 6A-D are schematic cross-sectional views illustrating alternate configurations of the acoustic barrier assembly of FIG. 5;

FIG. 7 is a top view of the acoustic barrier assembly of FIG. 5;

FIG. 8 is a flow diagram illustrating a non-limiting embodiment of a method of manufacturing a vehicle in accordance with the teachings disclosed herein;

FIG. 9 is a perspective view illustrating another non-limiting embodiment of an acoustic barrier assembly made in accordance with the teachings of the present disclosure;

FIG. 10 is a cross sectional view taken along the line 10-10 of FIG. 9;

FIG. 11 is a transparent view illustrating the acoustic barrier assembly of FIG. 9;

FIG. 12 is a perspective view illustrating another non-limiting embodiment of an acoustic assembly made in accordance with teaching of the present disclosure;

FIG. 13 is a schematic cross-sectional view illustrating a first alternate embodiment of the acoustic barrier assembly of FIG. 9;

FIG. 14 is a schematic cross-sectional view illustrating the first alternate embodiment illustrated in FIG. 13 at a different atmospheric pressure;

FIG. 15 is a schematic cross-sectional view illustrating a second alternate embodiment of the acoustic barrier assembly of FIG. 9;

FIG. 16 is a schematic cross-sectional view illustrating the second alternate embodiment of FIG. 15 as it encounters an unbalanced compressive force;

FIG. 17 is a schematic cross-sectional view illustrating a third alternate embodiment of the acoustic barrier assembly of FIG. 9;

FIG. 18 is a perspective view illustrating a non-limiting embodiment of a material suitable for use in the construction of an acoustic barrier assembly;

FIG. 19 is a perspective view of the material of FIG. 18 in a flexed state;

FIGS. 20A-20E are schematic cross-sectional views taken along the line A-A in FIG. 18 illustrating different embodiments of the material of FIG. 18, the differing embodiments having layers of differing widths;

FIGS. 21A-C are schematic cross-sectional views taken along the line A-A in FIG. 18 illustrating different embodiments of the material of FIG. 18, the differing embodiments having their layers arranged in differing sequences;

FIG. 22 is a perspective, cut-away view of a non-limiting embodiment of an acoustic barrier assembly constructed of a non-limiting embodiment of the material of the present disclosure;

FIG. 23 is a fragmentary side view illustrating a non-limiting embodiment of a conjunction between two pieces of the material of in FIG. 18; and

FIG. 24 is a non-limiting embodiment of a method for constructing an acoustic barrier assembly using a non-limiting embodiment of the material of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved acoustic barrier assembly is disclosed herein. In a non-limiting embodiment, the acoustic barrier assembly comprises a double wall structure that is configured to be positioned between the walls forming a bulkhead, the panels of a door, outer skin of a fuselage and cabin interior wall, and any other structure having a double wall configuration with hollow space situated therebetween. In other embodiments, the acoustic barrier assembly may be coupled with single wall structures. In still other embodiments, the acoustic barrier assembly may be employed in a stand-alone manner and need not be disposed between the two walls of a double wall structure or disposed adjacent a single wall structure.

In a non-limiting embodiment, the two walls forming the double wall structure of the acoustic barrier assembly are constructed of a gas impermeable material. As used herein, when referring to the materials used in the construction of the acoustic barrier assembly, the term “gas impermeable” means a material having the characteristic that lighter-than-air gases are physically precluded from passing completely through the material. In some embodiments, the gas impermeable material may be elastic while in other embodiments, the gas impermeable material may be substantially inelastic. In some embodiments, the gas impermeable material may be resistant to punctures. The two walls are positioned opposite one another and are coupled together such that a pocket is formed between the two walls. The coupling together of the two walls may be accomplished by sealing portions of the two walls to one another with an epoxy or other adhesive, by thermo-sealing (e.g., melting) the two walls together, by welding two flexible walls together, by one or more fasteners such as a clamp, by combinations of any of the foregoing, or by joining the two walls together in any other manner that yields a suitable fluid-tight seal. In an embodiment where the side walls of the acoustic barrier assembly are constructed of flexible material, the walls are inherently vibrationally isolated from one another so added vibration isolators may not be necessary. In embodiments where the side walls of the acoustic barrier assembly are constructed of inflexible material, vibration isolation between the two walls may be needed.

In a non-limiting embodiment, a valve is coupled to the double wall structure such that the valve is placed in fluid communication with an interior portion of the pocket. The valve is configured to be selectively opened and closed. When the valve is opened, a gas can be introduced into the pocket or evacuated therefrom. When the valve is closed, the two walls and side walls forming the pocket cooperate with the valve to seal the pocket in a fluid tight manner.

In a non-limiting embodiment, the pocket contains a gas having a molecular weight lower than the molecular weight of air. For ease of reference, this gas may be referred to herein as a “lightweight” gas. In an embodiment, the lightweight gas may be helium. The lightweight gas may be introduced into the pocket via the valve. In an embodiment, the pocket will be evacuated prior to the introduction of the lightweight gas. In another embodiment, the pocket may not be evacuated prior to the introduction of the lightweight gas but rather the introduction of the lightweight gas may cause the displacement of the heavier gas occupying the pocket. When the pocket is filled with the lightweight gas, the acoustic barrier assembly will have a shape that is suitable to allow the acoustic barrier to be introduced into, and maintained within, the space between the two walls of the structure that is to be insulated (e.g., a bulkhead, a door).

In other embodiments, it may be preferable to position the acoustic barrier assembly between the two walls of the structure to be insulated prior to the introduction of the lightweight gas into the pocket of the acoustic barrier assembly and to then inflate the pocket with the lightweight gas once the acoustic barrier assembly is in a desired position. This ability to inflate the acoustic barrier assembly after it is situated in the location where it is needed may make the acoustic barrier assembly of the present disclosure ideally suited for use in cavities, crevices, and other spaces that are difficult to access or that are non-uniform in their cross-sectional dimensions.

With the acoustic barrier assembly positioned between the two walls of a structure, such as a bulkhead or a fuselage cavity, and also in arrangements where the acoustic barrier assembly is employed in a stand-alone manner as the only structure disposed between locations needing to be sound insulated from one another, the acoustic barrier assembly of the present disclosure will provide superior sound mitigation compared to the prior conventional methods described above in the Background section. This is because the acoustic barrier assembly of the present disclosure employs a lightweight gas. The use of a lightweight gas such as, but not limited to, helium will substantially diminish the ability of the acoustic barrier assembly to transmit sound energy between the two walls of the acoustic barrier assembly. By virtue of their lower mass, the gas molecules of the lightweight gas will be less capable of transmitting energy. By way of analogy, an acoustic barrier assembly filled with ping pong balls will inherently be less capable of transmitting vibrations between the two walls of the acoustic barrier assembly than would an acoustic barrier assembly filled with billiard balls. This same principle applies at the molecular level.

In another non-limiting embodiment, the acoustic barrier assembly does not include a valve. Rather, the acoustic barrier assembly is filled with the lighter-than-air gas and sealed. In such embodiments, the material used in the construction of the acoustic barrier assembly and manner in which the acoustic barrier assembly is constructed will prevent the lightweight gas from seeping or leaking out of the pocket of the acoustic barrier assembly.

In another non-limiting embodiment, the acoustic barrier assembly will include a periphery wall. The periphery wall may comprise a separate component that has been coupled with the first wall and with the second wall in a manner that forms a fluid-tight pocket between the first wall and the second wall. In other embodiments, the periphery wall comprises a portion of the first wall and a portion of the second wall, such portions being coupled together to seal the fluid-tight pocket.

In another embodiment, the acoustic barrier assembly will include a biasing member disposed within the pocket. The biasing member is coupled with both the first wall and the second wall and is configured to help constrain movement of the first wall and the second wall towards and/or away from each other to facilitate maintenance of the overall shape and planform of the acoustic barrier assembly. For example, in embodiments where the first wall and/or the second wall are flexible, the biasing member will act in tension and inhibit the acoustic barrier assembly from spherically inflating. In embodiments where the first wall and the second wall are inflexible, the biasing member will act in compression and ensure that a portion of one of the walls does not collapse onto the other wall. The biasing member may also be employed in tension when both walls are inflexible to ensure that the periphery wall does not become taut. If the periphery wall were to become taut, it could potentially transmit vibrations between the two inflexible walls. This is undesirable. In some embodiments, a plurality of the biasing members may be employed.

As used herein with reference to the walls of the acoustic barrier assembly, the term “flexible” and “inflexible” are defined in terms of the deflection of the wall when the wall encounters a pressure differential between opposite sides of the wall (i.e., a greater pressure acting on one side of the wall than the other). In a non-limiting embodiment, the term “flexible” shall mean that a wall shall deflect by an amount equal to or greater than two percent of the longest length of the wall when the wall is subjected to a maximum anticipated pressure differential. In other embodiments, the specified percentage limitation may be three percent. In other embodiments, the specified percentage may be four percent. In still other embodiments, the specified percentage may be five percent. Furthermore, as used herein with reference to the walls of the acoustic barrier assembly, the term “inflexible” shall mean that a wall shall deflect by an amount less than two percent of the longest length of the wall when the wall is subjected to a maximum anticipated pressure differential on one side of the wall. In other embodiments, the specified percentage limitation may be three percent. In other embodiments, the specified percentage may be four percent. In still other embodiments, the specified percentage may be five percent. As used herein, the term “maximum anticipated pressure differential” shall mean the pressure differential that the wall encounters during standard operating conditions. For example, in the case of an aircraft, the maximum anticipated pressure differential refers to the difference between the static pressure inside of the acoustic barrier assembly and the ambient atmospheric pressure outside of the acoustic barrier assembly when the aircraft in which the acoustic barrier assembly is mounted is flown at the design cruising altitude of the aircraft.

An improved material for use in the construction of an acoustic barrier assembly is disclosed herein. In a non-limiting embodiment, the material comprises a multi-layered, flexible sheet having a first layer and a second layer. The first layer is flexible and is configured to be impermeable to a lightweight gas. The second layer is also flexible but has less flexibility than the first layer. In this non-limiting embodiment, it is the first layer that contains the lightweight gas within an acoustic barrier assembly constructed from the material and it is the second layer that provides the necessary rigidity needed to maintain the acoustic barrier assembly in a desired shape or configuration.

The first and second layers are coupled together in a sandwiched arrangement with one layer overlaying the other. The first and second layers may be coupled together in any suitable manner effective to maintain the layers in a coupled arrangement. In other non-limiting embodiments, the material may comprise additional layers. For example, the material may include a third layer comprising an adhesive or a mechanical configuration that facilitates coupling. In this manner, the third layer may permit the sheet of material to be coupled together with another sheet of the material by its respective third layer. In this manner, multiple sheets of the material to be joined together to form an acoustic barrier assembly. In yet another non-limiting embodiment, the material may include a fourth layer. The fourth layer may be configured to resist puncturing. Accordingly, the fourth layer may facilitate the use of an acoustic barrier assembly constructed from the material in environments that present sharp and/or pointy structures that might puncture the acoustic barrier assembly in the absence of the fourth layer.

In still other embodiments, additional layers may also be employed. For example, it may be desirable to provide a layer that provides protection against fire or other sources of elevated levels of heat. It may be desirable to provide a layer that insulates the material from extremely low temperatures. Further, any other layer that serves any other suitable purpose may also be employed without departing from the teachings of the present disclosure.

A greater understanding of the material for use in the construction of an acoustic barrier assembly, an acoustic barrier assembly constructed from the improved material and a method for constructing an acoustic barrier assembly out of the improved material may be obtained through a review of the illustrations accompanying this application together with a review of the detailed description that follows.

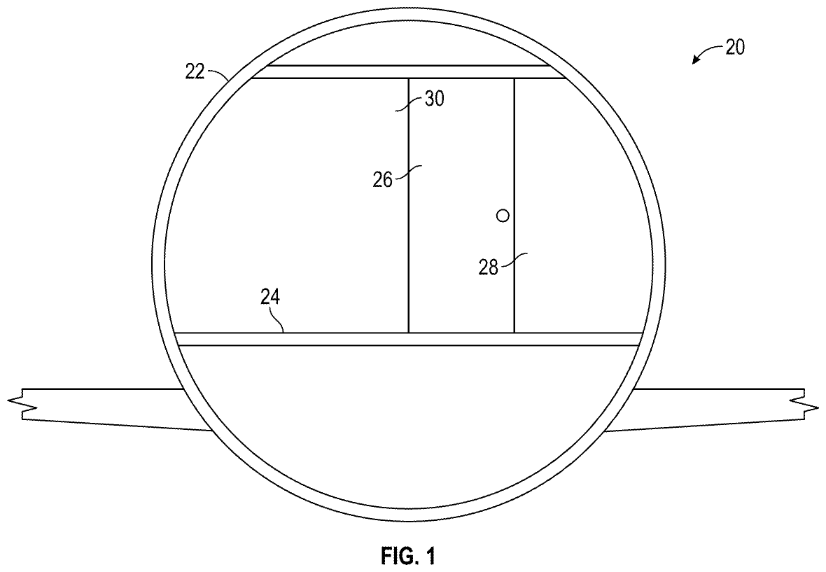

FIG. 1 is a fragmentary schematic cross-sectional view illustrating an aircraft 20. Aircraft 20 may comprise any type of aircraft including, without limitation, a subsonic aircraft, a supersonic aircraft, a propeller driven aircraft, a jet powered aircraft, a commercial airliner, a private business jet, a cargo aircraft, a military aircraft, and any other type of aircraft in which it is desirable to provide sound isolation. Additionally, although the acoustic barrier assembly of the present disclosure is being described and explained in the context of its application onboard an aircraft, it should be understood that the acoustic barrier assembly of the present disclosure is not limited to use onboard an aircraft. Rather, the acoustic barrier assembly of the present disclosure may be used in any type of vehicle including, but not limited to, automotive vehicles, surface and sub-surface watercraft, and spacecraft. Furthermore, the acoustic barrier assembly of the present disclosure is not limited to use in vehicles but may also be employed in other applications unrelated to vehicles such as, and without limitation, in the construction industry (e.g., building sound isolation into the walls of an apartment building) and in the furniture industry (e.g., building sound isolation into the partitions of office cubicles). In still other applications, the acoustic barrier assembly of the present disclosure may be employed in any industry and/or application where it is desirable to provide sound isolation.

Aircraft 20 includes a fuselage 22, a floor 24, a door 26, a bulkhead 28 and a bulkhead 30. In an exemplary embodiment, fuselage 22 separates occupants of aircraft 20 from the freestream air passing over and around aircraft 20 during flight. In an exemplary embodiment, floor 24 separates occupants of aircraft 20 from aircraft machinery such as landing gear, weapon systems, cargo, and avionics systems (not shown). In an exemplary embodiment, door 26, bulkhead 28, and bulkhead 30 cooperate to separate aircraft crew personnel from aircraft passengers. In each example given above, there is a partition that separates aircraft occupants from a source of sound (e.g., the freestream air, aircraft machinery, and other aircraft occupants, respectively). The partition may be constructed as a double wall or single wall.

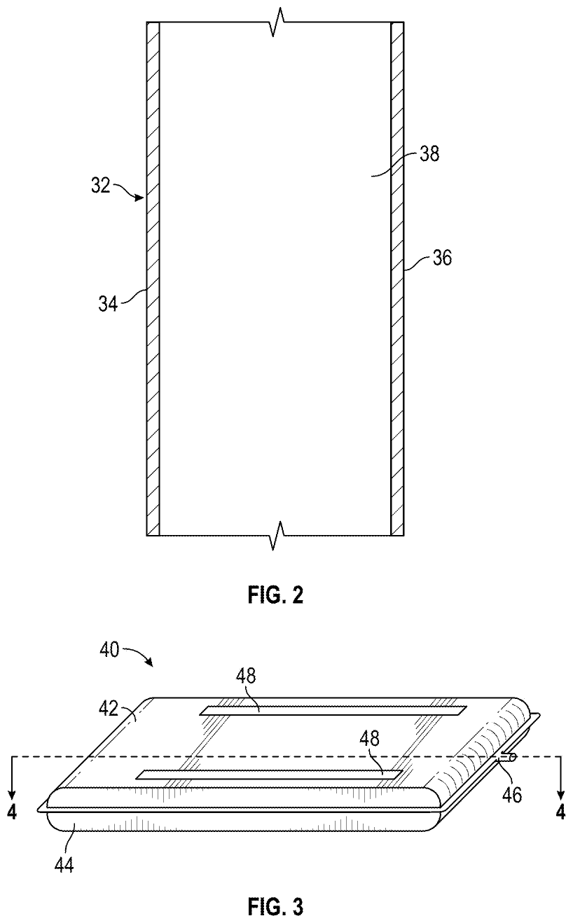

With continuing reference to FIG. 1, FIG. 2 is a fragmentary schematic cross-sectional view illustrating a partition 32. Partition 32 is an exemplary double wall constructed partition and may be suitable for use in the construction of fuselage 22, floor 24, door 26, and bulkheads 28 and 30. As illustrated, partition 32 includes a first wall 34, a second wall 36, and a cavity 38 disposed between first wall 34 and second wall 36. Cavity 38 is filled with air. If cavity 38 were to remain filled with air, then partition 32 would provide sound isolation commensurate with the level of sound isolation discussed in the Background section, above. This may be insufficient for situations that aircraft 20 is likely to encounter. Accordingly, it is desirable to position an acoustic barrier in cavity 38 to enhance the ability of partition 32 to inhibit the transmission of sound energy across partition 32.

In some embodiments, cavity 38 may have a three-dimensional rectangular configuration. Accordingly, it would be desirable to insert an acoustic barrier into cavity 38 that also has a three-dimensional rectangular configuration. In other embodiments, cavity 38 may have other three-dimensional configurations.

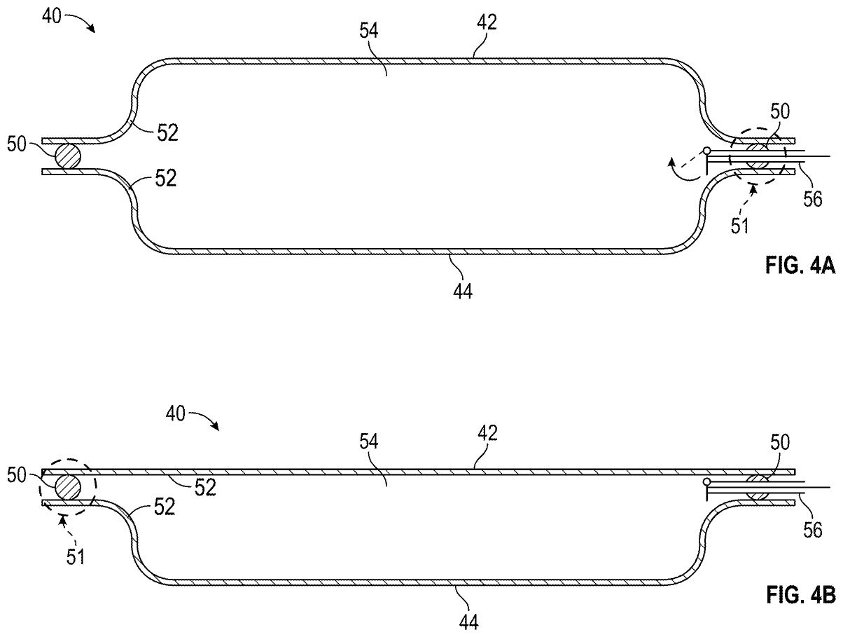

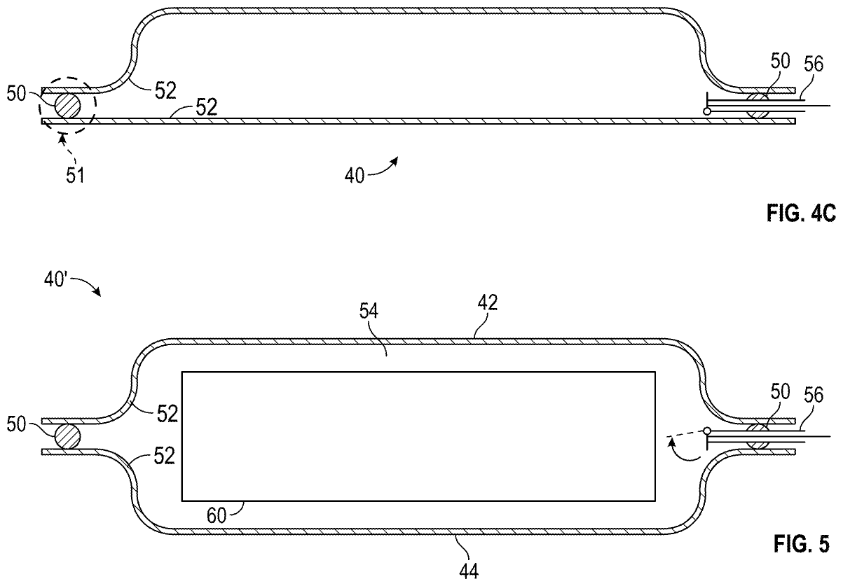

With continuing reference to FIGS. 1-2, FIG. 3 is a perspective view of a non-limiting embodiment of an acoustic barrier assembly 40. As illustrated, acoustic barrier assembly 40 has a generally three-dimensional rectangular configuration suitable for insertion into cavity 38. It should be understood that in other embodiments, acoustic barrier assembly 40 may have any other suitable shape and/or configuration that permits insertion into cavities having three-dimensional shapes other than a three-dimensional rectangular configuration. Acoustic barrier assembly 40 includes an upper wall 42 and a lower wall 44 coupled together forming a pocket therebetween (as best seen in FIGS. 4, 5, and 6A-D). A valve 46 provides fluid communication with the pocket and permits the introduction of gas into, and the extraction of gas from, the pocket. Acoustic barrier assembly 40 further includes a pair of coupling members 48 positioned along an upper surface (from the perspective of FIG. 3) of upper wall 42. In a non-limiting embodiment, pair of coupling members 48 may comprise double sided tape or a pair of hook-and-loop connectors (commonly known as Velcro™). In other embodiments, pair of coupling members 48 may alternatively be positioned along lower wall 44 while in still other embodiments, pair of coupling members 48 may be positioned along both upper wall 42 and lower wall 44.

With continuing reference to FIGS. 1-3, FIG. 4A is a schematic cross-sectional view of acoustic barrier assembly 40 taken along the line 4-4 of FIG. 3. For the sake of simplification, not every feature of acoustic barrier assembly 40 has been included in FIG. 4A. For example, pair of coupling members 48 have been omitted.

Upper wall 42 and lower wall 44 are each comprised of a material that is gas impermeable. Suitable materials for use in the construction of upper wall 42 and lower wall 44 include (collectively referred to herein as, the “walls”), but are not limited to, mono and composite layer films such as metallized polyester films, foils, or other substrates and elastomer coatings and specialty coated membrane films. In some embodiments, it may be desirable for the walls to be fabricated from a stiff material such as metal to facilitate the insertion of acoustic barrier assembly 40 into cavity 38. In other embodiments, it may be desirable for the walls to be fabricated from a more flexible material that permits the acoustic barrier assembly to be rolled up and inserted into cavity 38 and then unrolled once in place. In a non-limiting embodiment, upper wall 42 and lower wall 44 may be constructed of the same material. In other embodiments, upper wall 42 and lower wall 44 may be constructed of different materials.

As illustrated in FIG. 4A, upper wall 42 and lower wall 44 are coupled together by a mechanical coupling means 50. The ends of upper wall 42 and lower wall 44 and mechanical coupling means 50, together, form a seam 51. In the embodiment illustrated in FIG. 4A, seam 51 is centered between walls 42 and 44. It should be understood that in other embodiments, seam 51 may be disposed elsewhere on acoustic barrier 40. For example, in FIG. 4B, seam 51 is disposed at an upper end of acoustic barrier assembly 40 while in FIG. 4C, seam 51 is disposed at a lower end of acoustic barrier assembly 40. In other embodiments, seam 51 may be disposed at any suitable location on acoustic barrier assembly 40 without departing from the teachings of the present disclosure.

Mechanical coupling means 50 may comprise a bead of adhesive applied along substantially an entire periphery of upper wall 42 and lower wall 44. In other embodiments, mechanical coupling means 50 may comprise a thermo-coupling wherein the material comprising upper wall 42 and the material comprising lower wall 44 are melted together. In other embodiments, mechanical coupling means 50 may be a joint composed of a welding material that is heat coupled to both upper wall 42 and lower wall 44. In other embodiments, mechanical coupling means 50 may comprise a clamp or a series of clamps that extend along an entire perimeter of acoustic barrier assembly. In still other embodiments, any other means, method, mechanism, and/or combination thereof for coupling upper wall 42 and lower wall 44 together in a manner that provides for a fluid-tight coupling between upper wall 42 and lower wall 44 may be employed without departing from the teachings of the present disclosure.

With continuing reference to FIG. 4A, a pocket 52 is formed by upper wall 42 and lower wall 44. Pocket 52 is configured to contain a gas. A gas 54 is disposed within pocket 52. Gas 54 has a molecular weight lower than the molecular weight of air. Air has a weight of approximately 28 grams per mole. Accordingly, gas 54 has a molecular weight of less than 28 grams per mole. In one example, gas 54 is helium, having a weight of 4 grams per mole. In other examples, gas 54 may comprise any other gas having a mass per mole of less than 28 grams per mole.

A valve 56 extends through mechanical coupling means 50 and is fluidly coupled with pocket 52. Valve 56 permits gas 54 to be introduced into, and evacuated from, pocket 52. When valve 56 is closed (as illustrated in solid lines), it cooperates with upper wall 42, lower wall 44, and mechanical coupling means 50 to provide a fluid-tight container for gas 54. When valve 56 is opened (as illustrated in hidden lines), valve 56 permits the introduction or evacuation of gas 54 into and from, respectively, pocket 52. Valve 56 permits a construction worker or a maintenance worker to adjust the amount of gas 54 in pocket 52, as needed.

The size/dimensions of pocket 52 will expand and contract depending upon a number of factors including, but not limited to, the amount of gas disposed in pocket 52, the energy level of that gas, and the ambient atmospheric pressure outside of pocket 52. Accordingly, for a given number of gas molecules contained within pocket 52, the size/dimensions of pocket 52 may enlarge as the gas warms, it may diminish as the gas cools, it may enlarge as the ambient atmospheric pressure decreases, and it may diminish as the atmospheric pressure increases. The effects of changing atmospheric pressures and changing temperatures can be additive with one another in their impact on the size/dimensions of pocket 52 or they can offset one another in the impact they have on the size/dimensions of pocket 52. Familiarity with these factors can be helpful in tailoring acoustic barrier assembly 40 to fit snugly and/or loosely (as desired) within an allotted space in cavity 38 and/or to fit snugly or loosely (as desired) within cavity 38 when aircraft 20 is operating at a design altitude. For example, if it is desired that acoustic barrier assembly 40 fit snugly in cavity 38 between first wall 34 and second wall 36, and if it is known that aircraft 20 is designed to operate at an altitude of 50,000 feet, then both the temperature and ambient atmospheric pressure that acoustic barrier assembly 40 will encounter during aircraft operations are known. With a knowledge of the volume of space available in cavity 38 and in pocket 52 and with an understanding of the behavior of gas 54 under known temperature and pressure conditions, then an amount of gas 54 can be introduced into pocket 52 that will permit acoustic barrier assembly 40 to snugly fit within cavity 38 between first wall 34 and second wall 36.

With continuing reference to FIGS. 1-4, FIG. 5 is a schematic cross-sectional view illustrating an alternate embodiment of an acoustic barrier assembly 40′. Acoustic barrier assembly 40′ is substantially similar to acoustic barrier assembly 40. The primary difference between acoustic barrier assembly 40 and acoustic barrier assembly 40′ is that acoustic barrier assembly 40′ includes a body 60 disposed in pocket 52. Body 60 is configured to fit entirely within pocket 52 and to give acoustic barrier assembly 40′ its overall shape and to retain that overall shape regardless of whether gas 54 occupies pocket 52. In some embodiments, body 60 may be comprised of sub-bodies that may be arranged in an aligned manner to form a segmented body 60. In such embodiments, each sub-body may be positioned in direct contact with each adjacent sub-body to form body 60. In other embodiments, the sub-bodies may be spaced apart from one another such that some or all of the sub-bodies avoid direct contact with their neighboring sub-bodies. In other words, pocket 52 may contain a plurality of bodies 60. The use of multiple sub-bodies or the use of a plurality of bodies 60 provides for the opportunity to use different materials having different properties in a single acoustic barrier assembly 40′. It also provides for the opportunity to position acoustic barrier assembly 40′ inside of body cavities that are not planar in configuration, but which may have curvatures or bends or other non-linear spaces.

Body 60 may comprise any suitable material. In some embodiments, body 60 may comprise a sound absorbing material and thus may enhance the overall ability of acoustic barrier assembly 40′ to obstruct, inhibit, and/or absorb the transmission of sound between upper wall 42 and lower wall 44. Body 60 may be comprised of any suitable material, including, but not limited to, sound absorbing foam or fiber batting, and/or a limp mass barrier blanket. Foams may comprise open cell foams or partially open cell foams. Fiber batting may comprise fiberglass batting. Body 60 may also be constructed of fibrous blanket materials. Other suitable materials may also be employed without departing from the teachings of the present disclosure.

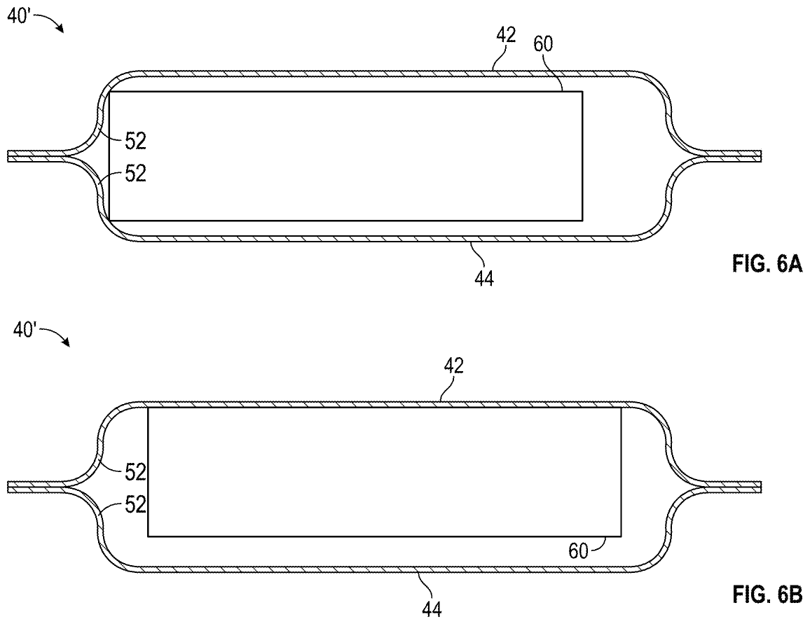

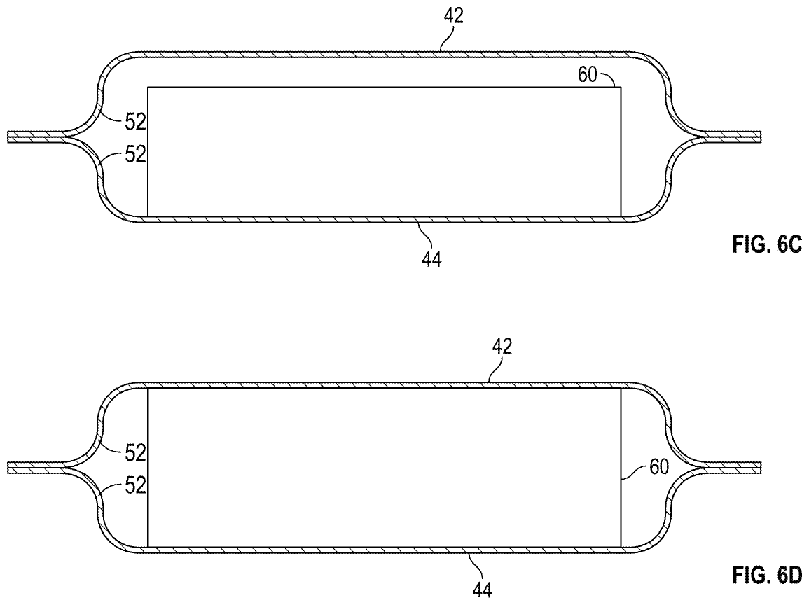

In FIG. 5, body 60 is depicted as floating freely within pocket 52, untethered to any interior surface of pocket 52. Accordingly, it should be understood that FIG. 5 illustrates a notional embodiment of acoustic barrier 40′. In practice, body 60 may be attached to one or more interior surfaces of pocket 52. Several such configurations are depicted in FIGS. 6A through 6D. In FIG. 6A, body 60 is secured to a left side portion of pocket 52 (e.g., a left side portion of upper wall 42 and lower wall 44) and is otherwise unsecured within pocket 52. In FIG. 6B, body 60 is secured to an upper surface of pocket 52 (e.g., a downward facing side of upper wall 42) and is otherwise unsecured within pocket 52. In FIG. 6C, body 60 is secured to a lower surface of pocket 52 (e.g., an upward facing side of lower wall 44) and is otherwise unsecured within pocket 52. In FIG. 6D, body 60 is secured to both an upper and lower surface of pocket 52 (e.g., to both a downward facing side of upper wall 42 and an upward facing side of lower wall 44) and is otherwise unsecured within pocket 52.

To ensure that body 60 does not contribute to the transmission of sound between upper wall 42 and lower wall 44, it is desirable for body 60 to be constructed of a compliant material. In a non-limiting example, such material may have a spring rate of no greater than two hundred pounds per inch per square inch of material. With continuing reference to FIGS. 4A-C, FIGS. 6A-D depict seam 51 disposed at a central location between upper wall 42 and lower wall 44. It should be understood that, as illustrated in FIGS. 4B and 4C, seam 51 may be disposed elsewhere on the acoustic barrier assembly.

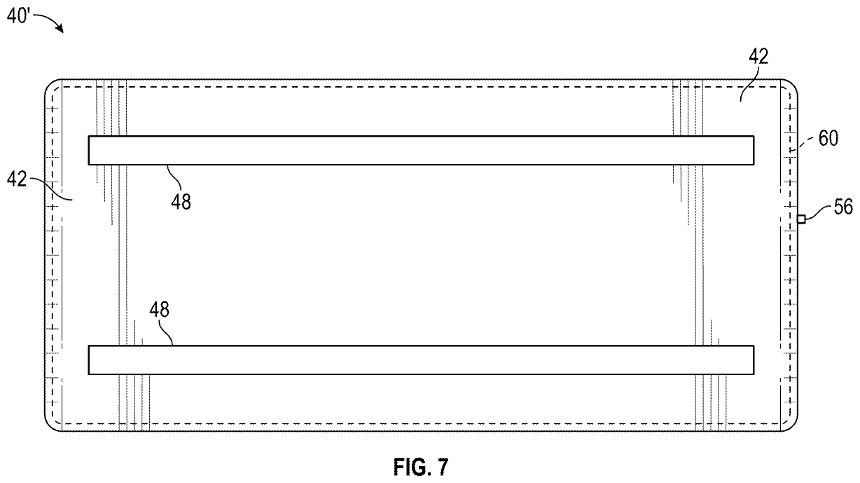

With continuing reference to FIGS. 1-6, FIG. 7 is a plan view of acoustic barrier assembly 40′. In FIG. 7, body 60 is illustrated in hidden lines. In this view, it can be seen that the overall shape and configuration of acoustic barrier assembly 40′ is provided by body 60. Body 60 serves as the skeletal structure for acoustic barrier 40′ while upper wall 42 and lower wall 44 serve as the skin. The structural rigidity imparted to acoustic barrier assembly 40′ by body 60 permits acoustic barrier assembly 40′ to be pushed into cavities.

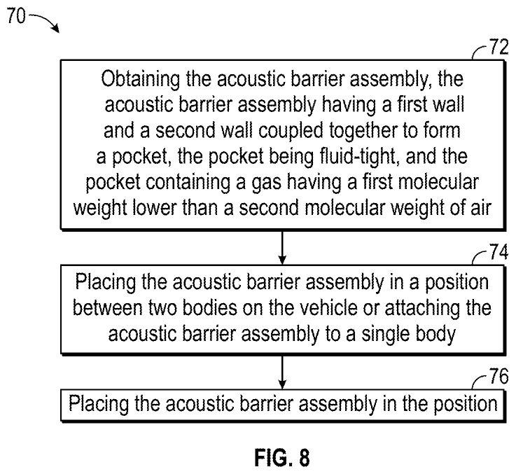

With continuing reference to FIGS. 1-7, FIG. 8 is a flow diagram illustrating the steps of a method 70 for manufacturing a vehicle with an acoustic barrier assembly. At step 72, an acoustic barrier assembly is obtained. The acoustic barrier assembly may have a first wall and a second wall coupled together to form a pocket. The pocket is fluid-tight meaning that it is configured to contain low molecular weight gas without leakage. The pocket further contains a gas. The gas has a molecular weight lighter than the molecular weight of air. In some embodiments, the acoustic barrier may comprise acoustic barrier assembly 40 or acoustic barrier assembly 40′, discussed above.

At step 74, the acoustic barrier is placed between two bodies on the vehicle. The two bodies are two bodies between which it is desired to provide sound isolation. In some examples, the two bodies may comprise the two walls of a double wall constructed door or bulkhead of an aircraft. In other examples, the two bodies may comprise the outer skin of a fuselage and the inner skin of a cabin. In still other embodiments, the two bodies may comprise any other structures between which it is desirable to provide sound isolation. In other embodiments, the acoustic barrier may be placed adjacent a single body without departing from the teachings of the present disclosure.

At step 76, the acoustic barrier assembly is affixed between the two bodies. In some embodiments, the acoustic barrier assembly may be affixed to one of the bodies while in other embodiments, the acoustic barrier assembly may be affixed to both bodies. In other embodiments employing single-walled construction, the acoustic barrier assembly may be affixed adjacent a single body. In some embodiments, the acoustic barrier assembly may be affixed using an adhesive, a tape, a hook-and-loop type fastener, a mechanical fastener, or any other means suitable to retain the acoustic barrier assembly in its position between the two bodies or adjacent the single body. In other embodiments, the acoustic barrier assembly may be held in place between the two bodies or on the single body by the features of those bodies without any additional means of fixation.

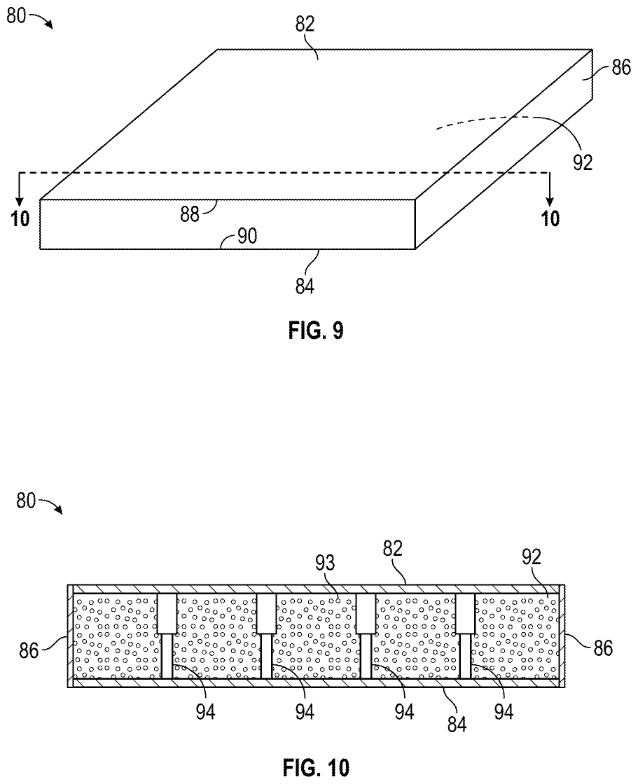

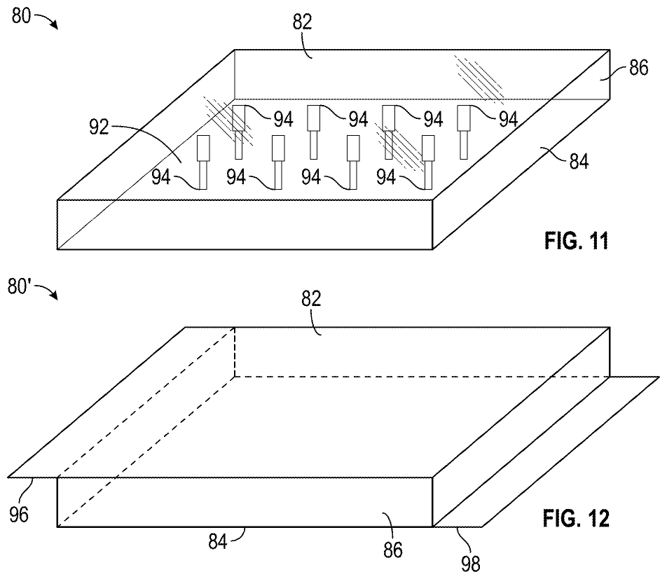

With respect to FIG. 9, a perspective view is presented illustrating another non-limiting embodiment of an acoustic barrier assembly 80 made in accordance with the teachings of the present disclosure. Acoustic barrier assembly 80 includes a wall 82 forming an upper surface of acoustic barrier assembly 80. Acoustic barrier assembly 80 further includes a wall 84 (best seen in FIGS. 10 and 11) forming a lower surface of acoustic barrier assembly 80. Wall 82 and wall 84 are each comprised of a gas impermeable material. Acoustic barrier assembly 80 further includes a periphery wall 86. Periphery wall 86 also comprises a gas impermeable material. In the illustrated embodiment, periphery wall 86 is coupled along a lateral edge 88 to a periphery of wall 82 and along an opposite lateral edge 90 to a periphery of wall 84. Opposite ends of periphery wall 86 are coupled with one another (not shown). The coupling of periphery wall 86 with wall 82 and wall 84 and the coupling of the longitudinal ends of periphery wall 86 to one another may be accomplished using any of the mechanisms and/or methods described above to provide a fluid-tight coupling. Arranged in this manner, walls 82 and 84, and periphery wall 86 cooperate to form a pocket 92. Because walls 82 and 84 and periphery wall 86 are each gas impermeable, and because periphery wall 86 is coupled with walls 82 and 84 via the gas-impermeable mechanisms and/or methods described above, pocket 92 comprises a fluid tight pocket that is able to contain a lighter-than-air gas.

With continuing reference to FIG. 1-9, FIG. 10 illustrates a cross-sectional view of acoustic barrier assembly 80 taken along line 10-10 of FIG. 9 and FIG. 11 illustrates a transparent view of acoustic barrier assembly 80. Accordingly, both FIGS. 10 and 11 provide a view of an interior portion of acoustic barrier assembly 80, including pocket 92.

As illustrated in FIG. 10, a lighter-than-air gas 93 is disposed within pocket 92. In some embodiments, lighter-than-air gas 93 may comprise helium. As discussed above, lighter-than-air gas 93 acts as an acoustic insulator and inhibits the transmission of sound and vibration from between walls 82 and 84. Lighter-than-air gas 93 further serves to occupy the space between walls 82 and 84. Because lighter-than-air gas 93 is a gas, it constantly exerts an outward pressure (i.e., static pressure) on an interior portion of walls 82 and 84, and on periphery wall 86, and thereby helps to keep walls 82 and 84 spaced apart from one another.

In some embodiments, acoustic barrier assembly 80 may be employed onboard an aircraft such as aircraft 20. While taxiing or parked, aircraft 20 will be in an environment where the ambient atmospheric pressure will be at or close to the atmospheric pressure at sea level. However, while in flight, the aircraft will be at an elevated altitude and will therefore be in an environment having an atmospheric pressure lower than that of sea level. Because acoustic barrier assembly 80 is sealed to contain lighter-than-air gas 93, acoustic barrier assembly 80 will expand and contract as lighter-than-air gas 93 expands and contracts in response to the changing atmospheric conditions. While the aircraft is on the ground, acoustic barrier assembly 80 will be in a relatively compact state due to the relatively high atmospheric pressure it encounters. However, while the aircraft is cruising at altitude, acoustic barrier assembly 80 will be in an expanded state due to the relatively low atmospheric pressure surrounding it. Accordingly, when employing acoustic barrier assembly 80 in the construction of a wall, door, or other structure that will be installed on a vehicle that will be subjected to changing atmospheric pressures, the spacing and positioning of one or more acoustic barrier assemblies 80 will need to be arranged in a manner that accommodates its changing volumetric requirements. In some embodiments, the goal may be to stack, arrange, and/or position acoustic barrier assemblies 80 in a manner such that, at the altitude of intended use, acoustic barrier assemblies 80 fill the space they are insulating and leave no gaps.

In a non-limiting embodiment, periphery wall 86 comprises a flexible material. In some non-limiting embodiments, the flexible material may be elastic while in other non-limiting embodiments, the flexible material may be inelastic. Therefore, depending upon the amount of lighter-than-air gas 93 that is disposed within pocket 92, periphery wall 86 may either have slack or it may be in tension. It is preferable for periphery wall 86 to be in a slack state to inhibit the transmission of sound energy or vibrations between walls 82 and 84. Accordingly, when filling pocket 92 with lighter-than-air gas 93, the different atmospheric pressures that acoustic barrier assembly 80 will be subjected should be considered. Accordingly, it is desirable to fill pocket 92 with an amount of lighter-than-air gas 93 that will avoid placing periphery wall 86 in tension when the vehicle reaches its design altitude. This can be calculated in a number of ways, including use of the hypsometric formula, as set forth below:

$$P = {{P}_{0} ( 1 - \frac{0.0065 h}{T + 0.0065 h + 273.15} )}^{5.257}$$

### Where:

Pₒ=Sea level pressure in hPa (eg, 1013.25 hPa=0 ft)

h=Altitude in meters (eg, 6000 ft=1828.7m)

T=Cabin Temperature in Celsius (eg, 72F=22.22C)

Using the noted formula with an aircraft with a cabin temperature of 72 degrees Fahrenheit, and a cabin altitude pressure of 6,000 ft, the perceived pressure in the cabin of the aircraft would equate to approximately 11.9 psi. The differential pressure is 11.9 psi-14.7 psi, or 2.75 psi. Therefore, an acoustic barrier assembly designed for a cabin altitude of 6,000 ft would require approximately 11.9 psi of lighter than air gas inserted into the pocket under standard sea level ambient conditions to achieve the desired shape. This assumes that the mass inside the acoustic barrier assembly remains constant when the volume is vacuumed to 11.9 psi absolute pressure at sea level.

With continuing reference to FIGS. 10 and 11, each figure illustrates a plurality of biasing members 94 arranged within pocket 92. As discussed in detail below, biasing members 94 may be configured to apply tension to walls 82 and 84 to ensure that they do not move further apart from one another than desired. Alternatively, as discussed in detail below, biasing members 94 may be configured to apply an outwardly directed bias to walls 82 and 84 to oppose movement of one wall towards the other beyond a desired point. In still other embodiments, biasing members 94 may be configured to provide both inwardly and outwardly directed bias to ensure that walls 82 and 84 do not move further apart or close together than desired. Suitable biasing members and mechanisms include, but are not limited to, springs, elastic bands, rubber bands, foam bodies, hydraulic struts, or pneumatic struts.

In the illustrated embodiment, there are a total of eight biasing members 94 depicted. However, it should be understood that a greater or smaller number of biasing members 94 may be employed without departing from the teachings of the present disclosure. For example, in some embodiments, a single biasing member may be sufficient to provide the desired bias to inhibit deformation of acoustic barrier assembly 80 beyond a predetermined limit. Additionally, while biasing members 94 have been depicted as being uniformly distributed throughout pocket 92, in other embodiments, it may be desirable to arrange biasing members 94 in a non-uniform manner. In some embodiments, it may be desirable to have a concentration of biasing members 94 near a center portion of acoustic barrier assembly 80 with few or none proximate to periphery wall 86. In other embodiments, it may be desirable to arrange biasing members 94 in close proximity to periphery wall 86 with few or none disposed near a center of acoustic barrier assembly 80.

In FIG. 10, periphery wall 86 is a separate component from wall 82 and from wall 84. It should be understood that in other embodiments, periphery wall 86 need not comprise a separate component, but instead may comprise a portion of wall 82 or a portion of wall 84 or a portion of both walls 82 and 84 without departing from the teachings of the present disclosure. In some embodiments, periphery wall 86 can act as a biasing member. In such embodiments, periphery wall 86 can act as the sole biasing member for acoustic barrier assembly 80 or it may act in combination with internal biasing members 94.

As discussed earlier with respect to FIGS. 1-8, acoustic barrier assembly 80 may also include a sound absorbing body (not shown) housed within pocket 92. For example, an open celled foam may be inserted in pocket 92 to assist with sound damping, to assist in the maintenance of the overall shape of acoustic barrier assembly 80, or both. Such an open cell foam may fill the volume of pocket 92 without being attached to any wall of acoustic barrier assembly 80. The low molecular weight gas may be inserted so that the walls compress the open cell foam at sea level. Then, when the aircraft reaches its operating altitude, the foam is allowed to expand to its natural uncompressed height (or it may remain slightly compressed) without the walls of acoustic barrier assembly 80 ballooning out. In some embodiments, a plurality of sound absorbing bodies may be disposed within pocket 92 and positioned between biasing members 94.

With continuing reference to FIGS. 1-11, FIG. 12 illustrates an alternate embodiment acoustic barrier 80′. Acoustic barrier 80′ is very similar to acoustic barrier 80. The primary difference between the two embodiments is that periphery wall 86 is coupled with only a portion of a periphery of wall 82 and coupled with only a portion of a periphery of wall 84. Coupled in this manner, an end portion of wall 82 forms a flap 96 and an end portion of wall 84 forms a flap 98. Flaps 96 and 98 can be used to couple multiple acoustic barrier assemblies 80 to one another. Such an arrangement may be necessary depending upon the application where acoustic barrier 80 is being employed. Such couplings can be accomplished via any of the methods and/or mechanisms described above, including via the use of removable attachment mechanisms such as, but not limited to, a hook and loop engagement mechanism.

With continuing reference to FIG. 12, in the illustrated embodiment, flaps 96 and 98 extend from opposite ends of acoustic barrier assembly 80′. It should be understood that other configurations are also possible. For example, and without limitation, flaps 96 and 98 can extend from the same end of acoustic barrier assembly 80′, from neighboring ends of acoustic barrier assembly 80′ from multiple ends of acoustic barrier assembly 80′ and from all ends of acoustic barrier assembly 80′ without departing from the teachings of the present disclosure.

With continuing reference to FIGS. 1-12, FIGS. 13 and 14 are schematic cross-sectional views illustrating another embodiment of the acoustic barrier assembly of the present disclosure—acoustic barrier assembly 100. Acoustic barrier assembly 100 has a wall 102, a wall 104, and a periphery wall 106 cooperating to enclose a pocket 108 in a fluid-tight manner in which a quantity of lighter-than-air gas is contained. Acoustic barrier assembly 100 further includes a plurality of biasing members 110. In the illustrated embodiment, biasing members 110 comprise elastic bands (e.g., rubber bands) that apply an inwardly directed force in the direction indicated by arrows 112. Walls 102 and 104 are comprised of a gas impermeable material that is flexible and/or elastic. The lighter-than-air gas will push against an internal surface of walls 102 and 104 and, in the absence of biasing members 110, would cause acoustic barrier assembly 100 to assume a spherical or quasi-spherical shape. The presence of biasing members 110 in pocket 108 oppose movement of walls 102 and 104 away from one another and hence counteract the tendency of the lighter-than-air gas to cause acoustic barrier assembly 100 to spherically deform.

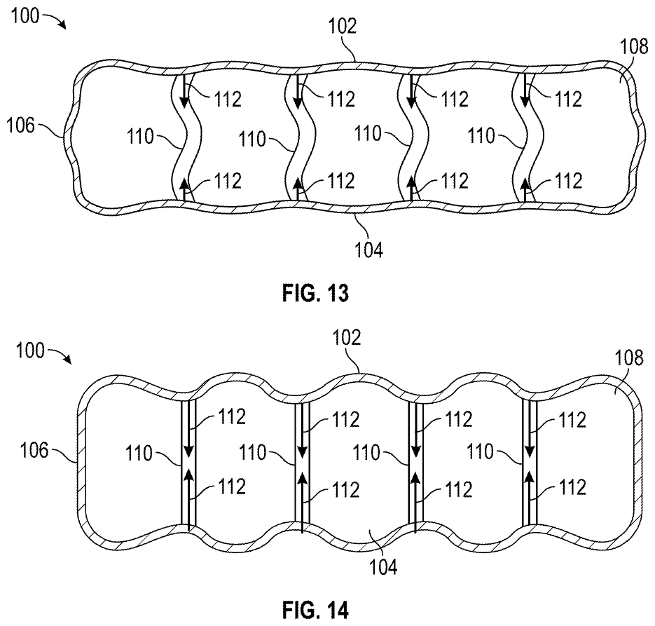

In FIG. 13, acoustic assembly 100 is located on an aircraft sitting at sea level. At sea level, acoustic assembly 100 encounters an atmospheric pressure of approximately 14.7 pounds per square inch. Acoustic barrier assembly 100 has been filled with a quantity of lighter-than-air gas that is intended to cause acoustic barrier assembly 100 to reach its expanded configuration (e.g., a configuration at which it will snugly fill the cavity on the aircraft that it was designed to fill) at a pressure altitude of four thousand feet, for example. Accordingly, at sea level, acoustic barrier assembly 100 encounters a relatively high atmospheric pressure and is therefore in a contracted state. At sea level, the atmospheric pressure is sufficient to contain the outward expansion of lighter-than-air gas in pocket 108 and the plurality of biasing members 110 are in a relatively relaxed or compressed state depending upon whether biasing members 110 are configured to pull or push, respectively, on walls 102 and 104. In this embodiment, the inner volume pressure will equalize to ambient pressure if pocket 108 is not restrained from collapsing in volume. The lighter-than-air gas in pocket 108 pushes, in a muted fashion, in an outward direction on walls 102 and 104. This can be discerned from the gentle curvature of the portions of wall 102 and wall 104 that are located between adjacent biasing members 110. While in the contracted configuration, there is an abundance of slack in periphery wall 106.

Acoustic barrier assembly 100 is still able to provide sound insulation while in a contracted state. However, because acoustic barrier assembly 100 may not extend across the entire interior of the cavity or because there may be gaps between acoustic barrier assembly 100 and the walls of its cavity or because there may be gaps between two adjacent acoustic barrier assemblies 100, there may be unobstructed pathways across which sound may travel. Accordingly, the overall effectiveness of acoustic barrier assembly 100 to insulate against sound will be reduced.

In FIG. 14, acoustic assembly 100 is located at an altitude of approximately 4,000 feet. At this altitude, the atmospheric pressure is about 12.7 pounds per square inch yielding a differential over the atmospheric pressure at sea level of about 2 pounds per square inch. In the face of this reduced atmospheric pressure, the lighter-than-air gas inside pocket 108 encounters less resistance from the atmosphere and it pushes wall 102 and wall 104 in an outward direction. Under these conditions, biasing members 110 exert a restraining force acting on acoustic barrier assembly 100 equal to the force exerted by the differential pressure between pocket 108 and the outside ambient air. Now, the lighter-than-air gas pushes more forcefully against the inner surface of walls 102 and 104 in an effort to expand outwardly until the inner and ambient forces acting on each wall are equalized. This outward expansion is prevented by biasing members 110. This can be observed by more severe curvature of the material of walls 102 and 104 located in between each biasing members 110, by the elongation of biasing members 110 and the corresponding increase in the arrows 112 indicating a greater tension in biasing members 110. Additionally, there is a reduction in the amount of slack present in periphery wall 106. The amount of lighter-than-air gas housed in pocket 108 has been calculated to ensure that periphery wall 106 does not become taut at the design altitude, otherwise periphery wall 106 may become a pathway for the transmission of sound energy and/or vibration.

With continuing reference to FIGS. 1-14, FIGS. 15 and 16 are schematic cross-sectional views illustrating another embodiment of the acoustic barrier assembly of the present disclosure—acoustic barrier assembly 120. Acoustic barrier assembly 120 has a wall 122, a wall 124, and a periphery wall 126 cooperating to enclose a pocket 127 in a fluid-tight manner in which a quantity of lighter-than-air gas is contained. Unlike acoustic barrier assembly 100 which had flexible walls 102 and 104, the walls of acoustic barrier assembly 120 (walls 122 and 124) are inflexible. Because walls 122 and 124 are inflexible, they inherently resist deformation and thus preclude acoustic barrier assembly 120 from spherically deforming under the urging of the lighter-than-air gas contained within pocket 127. The use of inflexible walls obviates the need to use elastic bands to prevent spherical deformation. However, inflexible walls will inherently have a heavier weight than flexible walls by virtue of the nature of the materials having flexible and inflexible qualities. This creates the possibility that one wall may approach or collapse towards the other under its own weight or in response to external compressive forces. The wall's inability to bend creates the possibility that one end of the wall may collapse towards the opposite wall while the opposite end of the collapsing wall is driven in the opposite direction away from the opposite wall. This lopsided compression/expansion can be exacerbated by the urging of the lighter-than-air gas that is driven from one end of acoustic barrier assembly 120 towards the other. This would give acoustic barrier assembly 120 a triangular or wedge-shaped cross-sectional profile and it would cause acoustic barrier assembly 120 to have a non-uniform distribution of the lighter-than-air gas in pocket 127. If unchecked, this could result in the narrow end of acoustic barrier assembly 120 having a diminished capacity to insulate against sound as compared with the wider end.

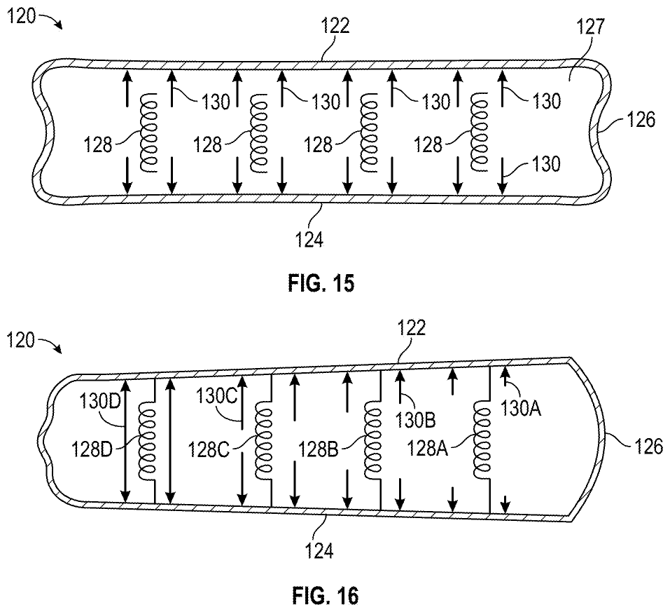

To address this concern, acoustic barrier assembly 120 includes a plurality of biasing members 128. In the illustrated embodiment, biasing members 128 comprise coil springs. In the embodiment illustrated in FIG. 15, biasing members 128 are each in a mild state of compression under the uniformly born weight of wall 122 and therefore each biasing member 128 is exerting a similar, mild, outwardly directed force (as indicated by arrows 130 all having approximately the same length) on walls 122 and 124. This outwardly directed force helps to keep walls 122 and 124 at a desired distance from one another and also helps to avoid uneven movement of one wall towards another. However, the biasing members are designed/chosen to have an appropriate spring constant and an appropriate dimension that avoids the application of an excessive amount of force to the walls. This maintains the opposite walls at a distance from one another that permits periphery wall 126 to remain in a relatively relaxed state of slack. Maintaining periphery wall 126 in a state of slack helps to avoid periphery wall 126 from becoming a pathway for the transmission of sound energy and vibration.

With continuing reference to FIGS. 1-15, FIG. 16 illustrates what would happen if one end of wall 122 were compressed towards or began to collapse under its own weight towards wall 124. As the left side of wall 122 (from the perspective illustrated in FIG. 16) moves towards the left side of wall 124, biasing members 128 act to prevent/mitigate the collapse. The load on the two biasing members 128 (biasing members 128A and 128B) on the right side of acoustic barrier assembly 120 is reduced as that end of wall 122 moves away from that end of wall 124. Consequently, the outward directed force exerted by biasing members 128A and 128B is reduced, as illustrated by the reduced length of the arrows 130A and 130B. This, in turn, curtails further the movement of the right side of wall 122 away from the right side of wall 124. In some embodiments, biasing members 128 may be selected such that movement of wall 122 away from wall 124 beyond a predetermined distance will place the biasing members in tension such that they would then actively oppose further outward movement of that portion of the walls. As the left side of wall 122 moves towards the left side of wall 124, the biasing members (biasing members 128C and 128D) on the left side of acoustic barrier assembly 120 are further compressed. This increases the amount of outward directed force exerted by biasing members 128C and 128D, as indicated by the increased length of arrows 130C and 130D. With a reduction in the outward force exerted on the right side of acoustic barrier assembly 120 and the contemporaneous increase in outward force being exerted on the left side of acoustic barrier assembly 120, the triangular or wedge-shaped configuration discussed above can be avoided or mitigated. The use of springs as a biasing member in this application inherently acts as a vibration isolating mechanism with respect to the transmission of vibrations between walls 122 and 124. Thus, despite the coupling of biasing members 128 to the inflexible walls 122 and 124, biasing members 128 will not serve as an efficient pathway for the transmission of vibration between walls 122 and 124.

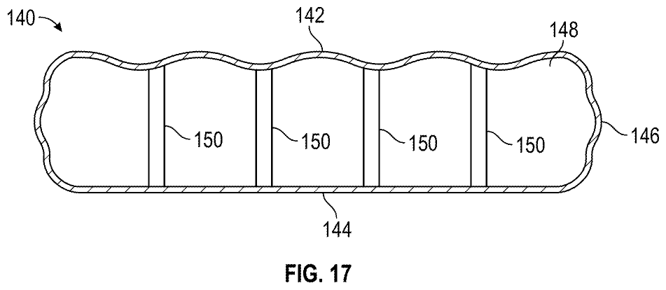

With continuing reference to FIGS. 1-16, FIG. 17 is a schematic cross-sectional view illustrating another embodiment of the acoustic barrier assembly of the present disclosure—acoustic barrier assembly 140. Acoustic barrier assembly 140 includes a wall 142, a wall 144, a periphery wall 146, a pocket 148, and biasing members 150. Unlike acoustic barrier assembly 100 in which both walls 102 and 104 were flexible, and unlike acoustic barrier assembly 120 in which both walls 122 and 124 were inflexible, in acoustic barrier assembly 140, wall 142 is flexible and wall 144 is inflexible. This allows acoustic barrier assembly 140 to be employed in unique or unconventional packaging spaces where acoustic barrier assemblies 100 and 120 may have limited efficacy. A rigid wall may be incorporated as a structural element for adjacent structures, for example, wall 144 could potentially be made of a gas impermeable honeycomb panel. Additionally, using one flexible wall instead of two inflexible walls may reduce the weight of the assembly. In some embodiments, rigid wall 144 could also be a single wall of the vehicle structure itself. Biasing members 150 may comprise any suitable type of biasing member necessary to prevent spherical deformation of acoustic barrier assembly 140 and to inhibit wall 144 from collapsing towards wall 142. Accordingly, in some embodiments, biasing members 150 may be able to exert both tension and compressive force.

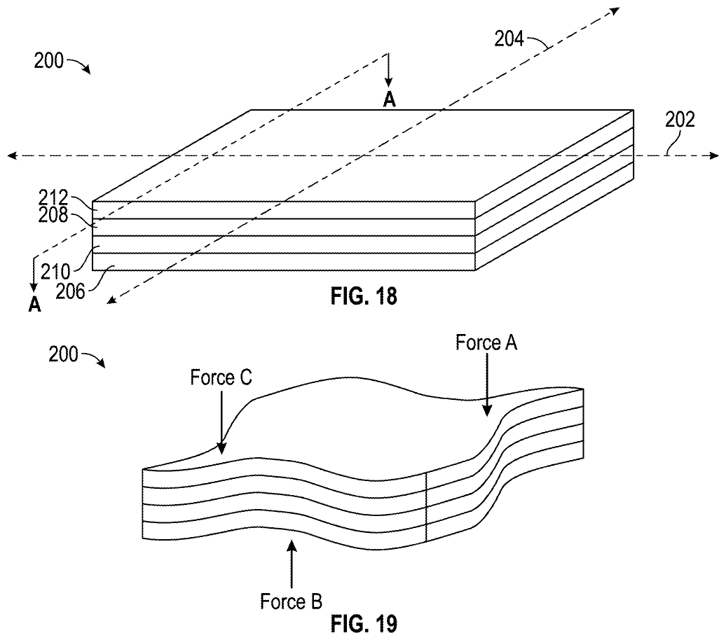

FIG. 18 is a perspective view of a sheet of a material 200. With continuing reference to FIGS. 1-17, as discussed in detail below, material 200 is configured to be suitable for use in the construction of acoustic barrier assembly 40, acoustic barrier assembly 80, acoustic barrier assembly 100, acoustic barrier assembly 120, acoustic barrier assembly 140, and any other acoustic barrier assembly made in accordance with the teachings disclosed herein. Furthermore, material 200 is not limited to use with acoustic barrier assemblies such as those disclosed herein but may also be employed in any other application that entails the containment of a gas and/or the containment of a lightweight gas, whether for the purpose of mitigating the transmission of sounds and/or noise or otherwise.

In the embodiment illustrated in FIG. 18, sheet of material 200 has a longitudinal axis 202 and a lateral axis 204. Material 200 is comprised of four distinct layers of differing materials. It should be understood that the sheet of material 200 depicted in FIG. 18 is a non-limiting embodiment of material 200. In other embodiments, material 200 may comprise fewer distinct layers of material without departing from the teachings disclosed here. In other embodiments, material 200 may include additional distinct layers of material without departing from the teachings disclosed here. In still other embodiments, material 200 may include one or more alternative distinct layers of material without departing from the teachings disclosed here.

In the embodiment illustrated in FIG. 18, material 200 includes a first layer 206. First layer 206 is configured to be flexible. First layer 206 is further configured to be impermeable to a lightweight gas. Any suitable material that is impermeable to a lightweight gas may be employed. In some embodiments, first layer 206 may comprise graphene oxide. Graphene oxide is known in the art as being a material that is impermeable to helium. Accordingly, if sheet of material 200 will be used in an application that requires the containment of helium, then first layer 206 may comprise graphene oxide. Alternatively, first layer 206 may comprise any other material now known or hereafter discovered that is impermeable to helium and that is flexible.

In the illustrated embodiment, first layer 206 is disposed at a bottom-most position (from the perspective of FIG. 18) of the four-layer arrangement of material 200. By positioning first layer 206 at the bottom-most location of material 200, first layer 206 may be positioned closest to the lightweight gas when sheet of material 200 is formed into a pocket or is joined together with additional sheets of material 200 to form a pocket. However, as discussed below, it should be understood that first layer 206 may be disposed at a different level of material 200 (e.g., any of the upper layers) without departing from the teachings of the present disclosure.

In the embodiment illustrated in FIG. 18, material 200 further includes a second layer 208. Second layer 208 is comprised of a flexible material. The flexible material comprising second layer 208 has a lower level of flexibility than the flexible material comprising first layer 206. In some non-limiting embodiments, second layer 208 has a flexibility that permits second layer 208 to maintain a given contour. In other words, if second layer 208 is bent, pressed, pushed, or otherwise give a desired shape, then once the force that has caused the desired shape is withdrawn, second layer 208 will substantially maintain that shape unless and until it is acted upon by another force. Configured in this manner, an acoustic barrier assembly constructed from material 200 will be able to maintain its design shape (i.e., the shape it is designed to have) due, at least in part, to the support provided by second layer 208. Second layer 208 may be comprised of any suitable material, including, but not limited to, any metals, alloys, plastics, or composites. In some embodiments, second layer 208 may comprise a thermal formed plastic or a pressure formed aluminum.

In the illustrated embodiment, second layer 208 is disposed at a level that is third-from-the-bottom position of the four-layer arrangement of material 200. By positioning second layer 208 at the third-from-the-bottom level of material 200, second layer 208 may be positioned in close proximity to an outer-most level of material 200. In this position, second layer 208 is well-positioned to serve as a quasi-exoskeleton for sheet of material 200 or for an acoustic barrier assembly constructed from one or more sheets of material 200 and thereby to maintain a desired design shape of sheet of material 200 or a desired design shape of an acoustic barrier assembly constructed from one or more sheets of material 200. However, as discussed below, it should be understood that second layer 208 may be disposed at a different level of material 200 without departing from the teachings of the present disclosure.

In the embodiment illustrated in FIG. 18, material 200 further includes a third layer 210. Third layer 210 is comprised of a flexible material. Third layer 210 is further configured to include at least one of an adhesive or a mechanical coupler or both. Accordingly, it is third layer 210 that facilitates the coupling of one edge of sheet of material 200 with either another edge of sheet of material 200 or with the edge of a second sheet of material 200. In other words, it is third layer 210 that primarily facilitates the assembly of an acoustic barrier assembly constructed from sheet(s) of material 200. In a non-limiting embodiment, third layer 210 may be comprised of any suitable material, including, but not limited to, a pressure sensitive acrylic, polyurethanes, single or two-part epoxies, and thermosetting adhesives. In some embodiments, it may be preferable to use a pressure sensitive acrylic or a thermoset polyurethane.

In the illustrated embodiment, third layer 210 is positioned at a level that is second from the bottom. By positioning third layer 210 at the second-from-the-bottom level of material 200, third layer 210 may be positioned adjacent to first layer 206. In this position, third layer 210 is well-positioned to control the position of first layer 206. Accordingly, when multiple sheets of material 200 are coupled together by third layer 210, the positioning of each respective first layer 206 in an adjoining or an abutting or an overlapping manner can be robustly maintained because of the close proximity of third layer 210. However, as discussed below, it should be understood that third layer 210 may be disposed at a different level of material 200 without departing from the teachings of the present disclosure.

In the embodiment illustrated in FIG. 18, material 200 further includes a fourth layer 212. Fourth layer 212 is comprised of a flexible material. Fourth layer 212 is further configured to have a higher resistance to puncturing than each of the other layers of material 200. Accordingly, it is fourth layer 212 that acts like a shell and protects material 200 and/or any acoustic barrier assembly constructed from sheets of material 200 from being punctured, from being penetrated, or from rupturing. Fourth layer 212 protects acoustic barrier assemblies that are constructed from sheet(s) of material 200 from deflating due to intrusions by external objects. In a non-limiting embodiment, fourth layer 212 may be comprised of any suitable material, including, but not limited to, puncture resistant metalized films, foils, or synthetic cloths. In an exemplary embodiment, fourth layer 212 may comprise Tyvek, synthetic cloth, or mylar foil/film.

In the illustrated embodiment, fourth layer 212 is positioned at a level fourth from the bottom. By positioning fourth layer 212 at the fourth-from-the-bottom level of material 200, fourth layer 212 is positioned at an outermost portion of sheet of material 200. In this position, fourth layer 212 is well situated to protect each of the other layers of material 200 from puncture, penetration, tearing and/or rupture. However, as discussed below, it should be understood that fourth layer 212 may be disposed at a different level of material 200 without departing from the teachings of the present disclosure.

In the embodiment illustrated in FIG. 18, sheet of material 200 has a substantially square configuration. Accordingly, the length of sheet of material 200 along longitudinal axis 202 is substantially equal to the width of sheet of material 200 along the lateral axis 204. However, it should be understood that sheet of material 200 is not limited to having a square configuration. Rather, it may have any suitable geometric configuration. In a non-limiting embodiment, material 200 may be manufactured in rolls similar to the rolls of paper that newspapers are printed on and then cut to any desirable length. Additionally, in the embodiment illustrated in FIG. 18, each of the layers of sheet of material 200 have substantially the same length as each of the other layers of sheet of material 200 along both lateral axis 204 and the longitudinal axis 202. As discussed below, in other embodiments, the various layers may have varying lengths along either or both lateral axis 204 and longitudinal axis 202.

With continuing reference to FIGS. 1-18, FIG. 19 is a perspective view illustrating sheet of material 200 as it is being subjected to various forces. A force A and a force C are being exerted in a downward direction on sheet of material 200 at opposite longitudinal ends of sheet of material 200 while a force B is being exerted in an upward direction at a longitudinally central portion of sheet of material 200. Because each of the various layers (first layer 206, second layer 208, third layer 210, and fourth layer 212) are flexible and able to bend in response to forces A, B, and C, sheet of material 200 as a whole is also flexible and is also able to bend in response to forces A, B, and C. The forces illustrated in FIG. 19 are merely exemplary in nature and are not intended to represent the only forces that may be applied to sheet of material 200 nor are they intended to represent the only forces that sheet of material 200 is able to tolerate.

An acoustic barrier assembly constructed from one or more sheets of material 200 may need to be mounted inside of a space having irregular contours and/or inconsistent depths and or widths. This may require the acoustic barrier assembly to bend at various locations. This may require the acoustic barrier assembly to bend along an entire lateral and/or longitudinal axis and take on an overall curved configuration. This may require the acoustic barrier assembly to become narrow at locations along its longitudinal and/or lateral axis. This may require the acoustic barrier assembly to assume still other shapes and configurations. Having this flexibility and ability to bend, as needed, allows an acoustic barrier assembly constructed from one or more sheets of material 200 to adapt and conform to irregularly shaped spaces. In addition, because it is flexible rather than rigid, material 200 is configured to act as a natural sound and vibration isolator. This is because vibrations are largely absorbed by flexible material rather than being transmitted by the material as would be the case if the material were rigid. Accordingly, fabricating an acoustic barrier assembly from a flexible material such as material 200 provides additional sound insulating capabilities to an acoustic barrier assembly containing a lightweight gas.

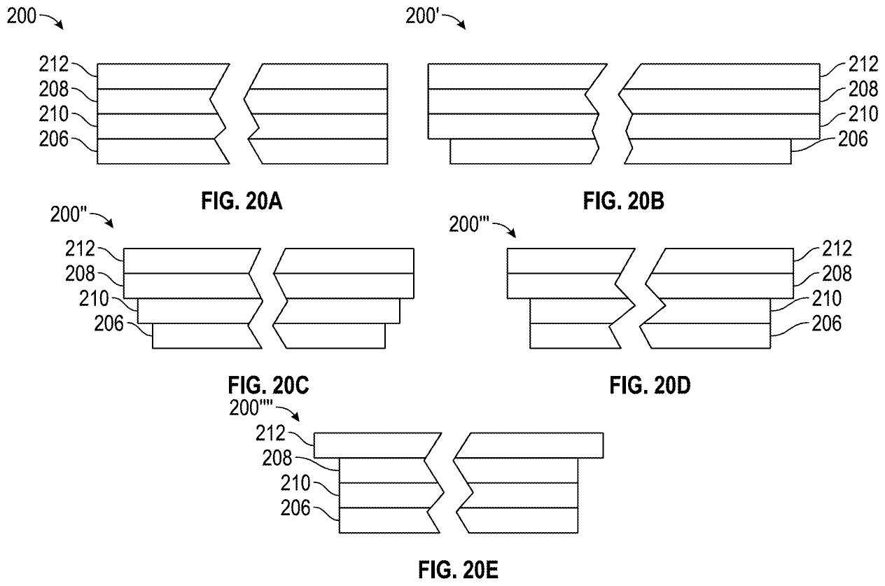

With continuing reference to FIGS. 1-19, FIG. 20A is a fragmented cross-sectional view of sheet of material 200 taken along the line A-A of FIG. 18 and FIGS. 20B through 20E are fragmented, cross-sectional views depicting various alternate embodiments of material 200. With respect to FIG. 20A, all four layers (first layer 206, second layer 208, third layer 210, and fourth layer 212) of material 200 have a substantially equal lateral dimension. For each of the alternate embodiments of material 200 depicted in FIGS. 20B through 20E, the lateral dimension of at least one of the layers varies.

With respect to FIG. 20B, a material 200′ is illustrated. Material 200′ includes the same four layers as material 200, but in material 200′, first layer 206 has a smaller lateral dimension than do second layer 208, third layers 210, and fourth layer 212. Arranged in this manner, when multiple sheets of material 200′ are coupled together along their lateral edges, their respective second layers 208, third layers 210, and fourth layers 212 can engage and enmesh with one another in an overlapping manner to an extent that permits respective first layers 206 to be arranged in an abutting configuration with the edge of each first layer 206 positioned immediately adjacent to one another without lapping. This configuration may provide cost and weight savings advantages over material 200. Further, this configuration may provide additional assembly, mounting, and installation benefits.

With respect to FIG. 20C, a material 200″ is illustrated. Material 200″ includes the same four layers as material 200, but in material 200″, third layer 210 has a smaller lateral dimension than second layer 208 and fourth layer 212 but a larger lateral dimension than first layer 206. Arranged in this manner, when multiple sheets of material 200″ are coupled together along their lateral edges, their respective second layers 208, third layers 210, and fourth layers 212 can engage and enmesh with one another in an overlapping manner to an extent that permits respective first layers 206 to be arranged immediately adjacent to one another without lapping. In addition, respective third layers 210 will have less overlap than respective second layers 208 and respective fourth layers 212. This configuration may provide cost and weight savings advantages over material 200 and it may provide a further advantage over both material 200 and material 200′ by providing a lower profile seam at the intersection of each respective sheet of material. Furthermore, this configuration may provide additional assembly, mounting, and installation benefits.

With respect to FIG. 20D, a material 200′″ is illustrated. Material 200′″ includes the same four layers as material 200, but in material 200′″, third layer 210 now has an even smaller lateral dimension than it did in material 200″ such that its lateral dimension is now substantially equal to the lateral dimension of first layer 206. Additionally, first layer 206 and third layer 210 each have a smaller lateral dimension than second layer 208 and fourth layer 212. Arranged in this manner, when multiple sheets of material 200′″ are coupled together along their lateral edges, their respective second layers 208 and fourth layers 212 can engage and enmesh with one another in an overlapping manner to an extent that permits respective first layers 206 and respective third layers 210 to be arranged in an abutting configuration with their respective lateral edges being positioned immediately adjacent to one another without lapping. This configuration may provide cost and weight savings advantages over material 200 and it may provide a further advantage over both material 200, material 200′, and material 200″ by providing an even lower profile seam at the intersection of each respective sheet of material. Additionally, this configuration may provide additional assembly, mounting and installation benefits.

With respect to FIG. 20E, a material 200″″ is illustrated. Material 200″″ includes the same four layers as material 200, but in material 200″″, first layer 206, second layer 208, and third layer 210 each have the same lateral dimension while fourth layer 212 has a larger lateral dimension than the other three layers. Arranged in this manner, when multiple sheets of material 200″ are coupled together along their lateral edges, their respective fourth layers 212 can engage and enmesh with one another in an overlapping manner to provide an added measure of puncture resistance. Additionally, first layers 206, second layers 208, and third layers 210 can be arranged so as to abut up against one another and be positioned immediately adjacent to one another. This configuration may provide even greater cost and weight savings advantages over material 200. In addition, the above described configuration may provide an acoustic barrier assembly constructed from material 200″″ with an even greater flexibility than an acoustic barrier assembly constructed of material 200 or of material 200′ or of material 200″ or of material 200′″ because of the minimal amount of overlap of the various layers of material 200″″. In addition, material 200″ may provide a further advantage over material 200, material 200′, material 200″, and material 200′″ by providing an even lower profile seam at the intersection of each respective sheet of material. Additionally, this configuration may provide additional assembly, mounting, and installation benefits.

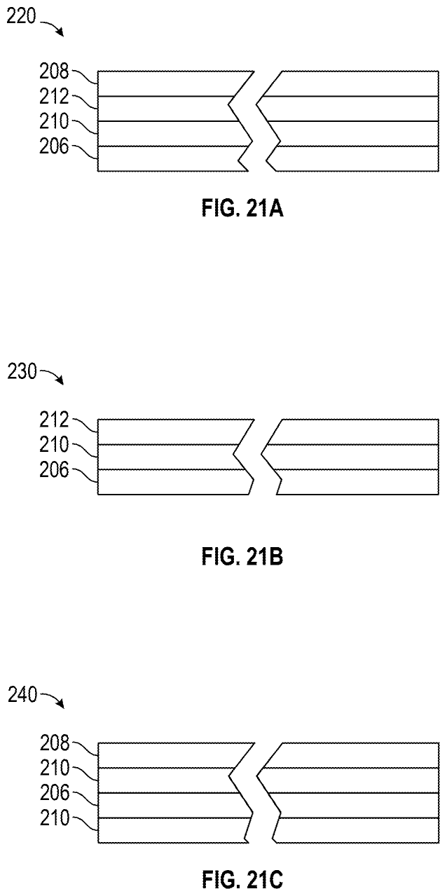

With continuing reference to FIGS. 1-20E, FIGS. 21A-C are fragmented, cross-sectional views of alternate embodiments of material 200 taken along the line A-A of FIG. 18. These alternate embodiments illustrate differing sequences of the various layers of material 200 and, in the case of FIG. 21B, an alternate embodiment of material 200 is illustrated that has fewer layers than material 200, all of which is discussed in detail below.

FIG. 21A illustrates a material 220 that, similar to material 200, may be used in the construction of an acoustic barrier assembly that is intended to contain a lightweight gas. Material 220 is constructed of the same layers as material 200, but with material 220, the layers are arranged in a different sequence. First layer 206 occupies the bottom level of material 220 as it did in material 200. Similarly, third layer 210 is disposed at the second from the bottom level as it did in material 200. The difference between material 200 and 220 is found in the third and fourth levels from the bottom. In material 220, it is fourth layer 212 that occupies the third from the bottom level and it is second layer 208 that occupies the fourth from the bottom level. Said another way, the difference between material 220 and material 200 is that in material 220, the puncture resistant layer is contained within the flexible layer that gives material 220 its shape. This may be advantageous in situations or environments in which environmental temperature conditions, such as extreme heat, excessive cold, or large temperature swings from both heat and cold are anticipated. Further, this may be advantageous by providing environmental wear protection from dust, debris, particulates or moisture.

FIG. 21B illustrates a material 230 that, similar to material 200, may be used in the construction of an acoustic barrier assembly that is intended to contain a lightweight gas. Material 230 is constructed of the same layers as material 200, but omits one layer. Material 230 includes first layer 206, third layer 210, and fourth layer 212, but omits second layer 208. In this embodiment, first layer 206 again occupies the bottom or inner-most level of material 230 as it did in material 200. Similarly, third layer 210 is disposed at the second from the bottom level as it did in material 200. Fourth layer 212 occupies the outermost level of material 230, as it did in material 200. By omitting second layer 208, considerable cost and weight savings for material 230 can be obtained. It may be advantageous to construct an acoustic barrier assembly from material 230 in situations where it is anticipated that the environment in which the acoustic barrier assembly will housed will be relatively confined and the walls of the environment itself will give the acoustic barrier assembly its shape and thus there is less of a need for acoustic barrier assembly to independently maintain its own shape. It may also be advantageous to utilize material 230 in the construction of an acoustic barrier assembly in circumstances where electromagnetic interference is a concern, and a metalized/alloy construction may prevent safe operation and communications from being adjacent to telecommunications devices or antennas that are sensitive to metals. Internally, communications protocols of concern may include WIFI, Bluetooth, or similar inter-device communications. Externally, communications protocols of concern may include air-to-ground or air-to-space antennas.

FIG. 21C illustrates a material 240 that, similar to material 200, may be used in the construction of an acoustic barrier assembly that is intended to contain a lightweight gas. Material 240 is constructed of many of the same layers as material 200, but not all of those layers are included here and those that are, are not in the same sequence. In this embodiment, first layer 206 occupies the second from the bottom position of material 240. Second layer 208 is disposed at an outermost position in material 240. Material 240 includes two third layers 210, one layer being disposed at the bottom or inner most level and a second layer being disposed at the third from the bottom level such that the two third layers 210 sandwich first layer 206. Material 240 omits fourth layer 212. Use of material 240 in the construction of an acoustic barrier assembly may be advantageous in situations or environments in which the acoustic barrier assembly will be exposed to large swings in external pressure but without the likelihood of intrusion by a penetrating object. The use of two third layers 210 ensures that in a highly variable ambient pressure environment, there will be two layers of adhesive or mechanical couplings holding the acoustic barrier assembly together rather than just one. Other advantages of material 240 include adhering to adjacent blanks or adhering directly to the substrate (airframe, cabinetry, and the like) in place of hook and loop fasteners.

With continuing reference to FIGS. 1-21C, FIG. 22 is a cut-away, perspective view illustrating a non-limiting embodiment of an acoustic barrier assembly 250 made in accordance with the teachings of the present disclosure. The various ways in which an acoustic barrier assembly can be constructed and configured, as well as the various features and advantages of such configurations, have been discussed extensively above and, for the sake of brevity, will not be repeated here.

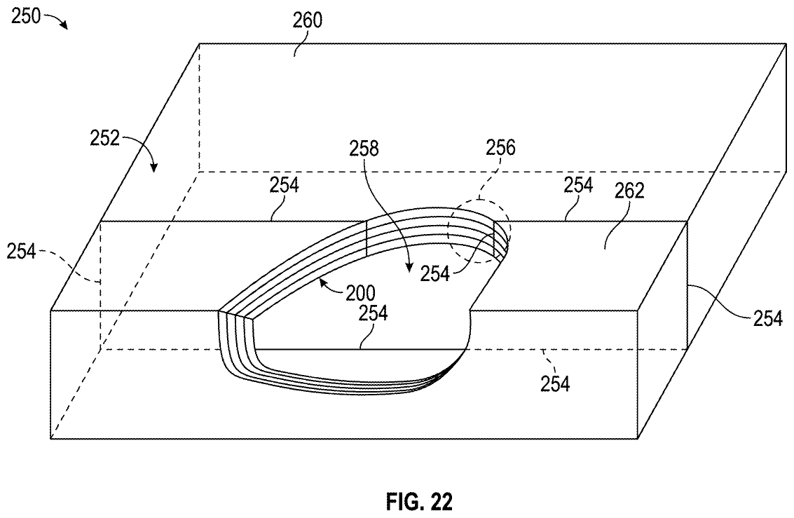

As illustrated in FIG. 22, acoustic barrier assembly has been partially torn away to expose an interior portion of acoustic barrier assembly 250. The torn-away portion of acoustic barrier assembly 250 reveals the material used in the construction of acoustic barrier assembly 250. In the embodiment illustrated in FIG. 22, acoustic barrier assembly 250 has been constructed from material 200. It should be understood that the embodiment illustrated in FIG. 22 is a non-limiting embodiment. In other embodiments, any of the alternate embodiments of material 200 discussed above and illustrated in FIGS. 20A-E and 21A-C may be employed in the construction of acoustic barrier assembly 250 without departing from the teachings of the present disclosure. In still other embodiments, any other material configured to contain lightweight gas may be employed without departing from the teachings of the present disclosure. In still other embodiments, any other material configured to contain helium may be employed without departing with the teachings of the present disclosure.

In a non-limiting embodiment, acoustic barrier assembly 250 may be constructed from a single sheet of material 200 or from a single sheet of any of the alternate embodiments of material 200 discussed above or from any other material suitable for the containment of a lightweight gas. In another non-limiting embodiment, acoustic barrier assembly 250 may be constructed from multiple sheets of material 200 that have been joined together or from multiple sheets of the alternate embodiments of material 200 discussed above or from multiple sheets of any other material suitable for the containment of a lightweight gas.

In the embodiment illustrated in FIG. 22, acoustic barrier assembly 250 has been constructed from multiple sheets of material 200. As illustrated in FIG. 22, an upper surface 252 of acoustic barrier assembly 250 includes a first wall 260 and a second wall 262 joined together at a seam 254. In the illustrated embodiment, first wall 260 and second wall 262 each comprise a sheet of material 200 that have been joined together to cooperate to contain a lightweight gas. In the illustrated embodiment, seam 254 continues around an entire periphery of acoustic barrier assembly 250. A portion of seam 254 has been identified by a phantom-line circle 256. This portion of seam 254 will be discussed in greater detail below. In other embodiments, a greater or lesser number of seams may be present on upper surface 252, depending upon how many discrete sheets of material 200 have been coupled together to complete the construction of acoustic barrier assembly 250. First wall 260 and second wall 262, together with additional sheets of material 200, have been joined together to form a pocket 258. Pocket 258 is fluid tight and configured to contain a lightweight gas. In the illustrated embodiment, pocket 258 contains helium.

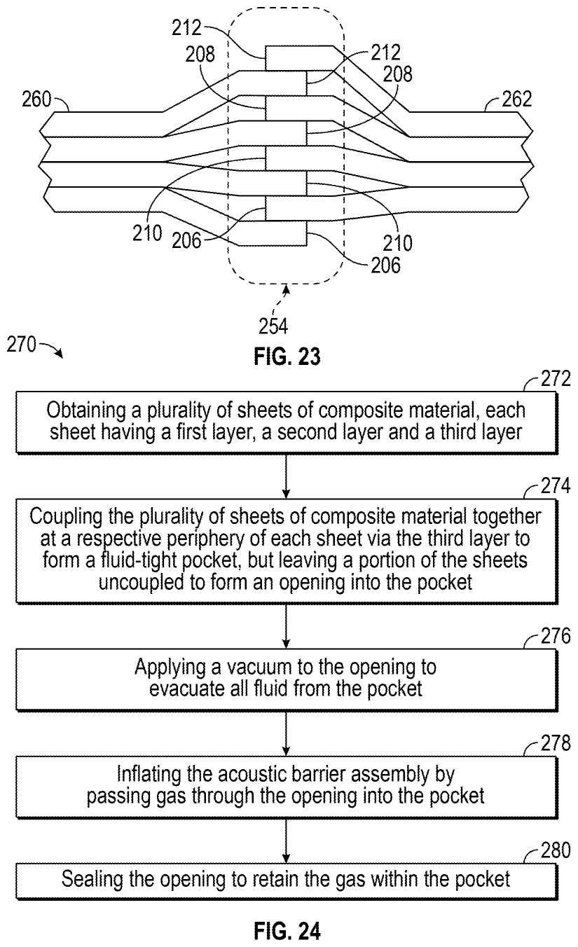

With continuing reference to FIGS. 1-22, FIG. 23 is an expanded, fragmented side view illustrating the portion of acoustic barrier assembly 250 identified by phantom-line circle 256 in FIG. 22. FIG. 23 illustrates the manner in which first wall 260 and second wall 262 have been coupled together. As illustrated the respective layers of each wall have been overlapped and dovetailed into one another. Accordingly, an end portion of first layer 206 of second wall 262 has been overlapped with an end portion of first layer 206 of first wall 260. Above that, an end portion of third layer 210 of first wall 260 has been overlapped with the end portion of first layer 206 of second wall 262. Above that, an end portion of third layer 210 of second wall 262 has been overlapped with the end portion of third layer 210 of first wall 260. And so on, with each of the remaining layers having their respective end portions overlapped with, and sandwiched between, each of the end portions of the opposite sheets' layers. As a result, a robust, fluid-tight coupling between first wall 260 and second wall 262 is obtained.

With continuing reference to FIGS. 1-23, FIG. 24 illustrates a non-limiting embodiment of a method 270 of assembling an acoustic barrier assembly. An acoustic barrier assembly that has been assembled via method 270 may comprise any of the various acoustic barrier assemblies discussed above, such as acoustic barrier assembly 40, acoustic barrier assembly 80, acoustic barrier assembly 100, acoustic barrier assembly 120, acoustic barrier assembly 140, and acoustic barrier assembly 250. In still other embodiments, method 270 may be employed in the construction of any other acoustic barrier assembly suitable for containing a lightweight gas.

At step 272, a plurality of sheets of material are obtained. In an embodiment, the material may comprise material 200. In other embodiments, the material may comprise any other suitable material, now known or hereafter discovered and/or invented, that is configured to contain a lightweight gas including, but not limited to, helium.

At step 274, the plurality of sheets of material are coupled together at their respective peripheries to form a pocket to contain the lightweight gas. The sheets of material are coupled together via their respective third layers to form a fluid-tight coupling. The coupling is configured to contain the lightweight gas. In one embodiment, the lightweight gas comprises helium. In an embodiment, the third layers comprise a heat activated adhesive and the method includes applying heat to the seam to activate the adhesive. When coupling the plurality of sheets of material together, a portion of one coupling between two sheets of material will remain uncoupled to form an opening to the pocket formed by the sheet(s) of material. In this manner, there will be, at least temporarily, a fluid communication between the pocket and the outside of the acoustic barrier assembly. This opening will be used later to inflate the acoustic barrier assembly with the lightweight gas.

In some embodiments of method 270, a step 276 is performed. At step 276, a vacuum is applied to the opening to evacuate all fluid from within the pocket. This step may be performed prior to the introduction of the lightweight gas into the pocket to ensure that when the lightweight gas is introduced into the pocket, the lightweight gas will be the only gas occupying the pocket. In other embodiments of method 270, a vacuum is not applied to the opening prior to filling the pocket with the lightweight gas.

At step 278, the lightweight gas is introduced into the pocket through the opening to inflate the acoustic barrier assembly with the lightweight gas. In some embodiments, the lightweight gas may comprise helium. In embodiments of method 270 that include step 276 (i.e., applying a vacuum to the opening prior to filling the pocket with the gas), the lightweight gas enters the opening, fills the pocket, and inflates the acoustic barrier assembly. In embodiments of method 270 that do not include step 276, the introduction of the lightweight gas through the opening into the pocket has the effect of displacing any heavier gas from the pocket. As the lightweight gas enters the pocket, because it is less dense than the heavier gas (e.g., air), the lightweight gas will rise and begin to fill the pocket from the top. As the lightweight gas continues to flow into the pocket, it will push the heaver gas downward to, and out through, the opening. In an embodiment, sensors can be employed to detect when the gas exiting the opening changes from the heavier gas to the lightweight gas. Once lightweight gas is detected exiting through the opening, this means that the pocket is full of the lightweight gas.

At step 280, once a desired amount of the lightweight gas has filled the pocket, the opening is sealed. The opening may be sealed via any acceptable method including, but not limited to the same process by which the sheets of material were coupled together in step 274. As a result, the lightweight gas will be permanently contained within the pocket.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A material for use in construction of an acoustic barrier assembly, the material comprising:
a first layer comprising a first flexible material, the first flexible material configured to be impermeable to a lightweight gas; and
a second layer coupled with the first layer, the second layer comprising a second flexible material, the second flexible material having less flexibility than the first flexible material.

2. The material of claim 1, wherein the first flexible material is configured to be impermeable to helium.

3. The material of claim 1, wherein the first flexible material comprises graphene oxide.

4. The material of claim 1, further comprising a third layer coupled with one of the first layer and the second layer, the third layer comprising a third flexible material, the third layer further comprising an adhesive.

5. The material of claim 4, further comprising a fourth layer coupled with one of the first layer, the second layer, and the third layer, the fourth layer comprising a fourth flexible material, the fourth flexible material configured to have a higher resistance to puncturing than the first flexible material, the second flexible material, and the third flexible material.

6. The material of claim 5, wherein the first layer has a first width that is less than a second width of the second layer.

7. The material of claim 5, wherein the first layer has a first width that is less than a second width of the second layer and less than a third width of the third layer

8. The material of claim 5, wherein the first layer has a first width that is less than a second width of the second layer and less than a third width of the third layer and less than a fourth width of the fourth layer.

9. The material of claim 5, wherein the first layer and the fourth layer are disposed on opposite sides of the material.

10. An acoustic barrier assembly comprising:
a first wall formed of a material;
a second wall formed of the material, the second wall coupled with the first wall, the first wall and the second wall cooperating to form a pocket; and
a lightweight gas contained within the pocket,
wherein the material comprises:
a first layer comprising a first flexible material, the first flexible material configured to be impermeable to the lightweight gas; and
a second layer coupled with the first layer, the second layer comprising a second flexible material, the second flexible material having less flexibility than the first flexible material.

11. The acoustic barrier assembly of claim 10, wherein the lightweight gas comprises helium.

12. The acoustic barrier assembly of claim 10, wherein the first flexible material comprises graphene oxide.

13. The acoustic barrier assembly of claim 10, wherein the material further comprises a third layer coupled with one of the first layer and the second layer, the third layer comprising a third flexible material, the third layer further comprising an adhesive.

14. The acoustic barrier assembly of claim 13, wherein the material further comprises a fourth layer coupled with one of the first layer, the second layer, and the third layer, the fourth layer comprising a fourth flexible material, the fourth flexible material configured to have a higher resistance to puncturing than the first flexible material, the second flexible material, and the third flexible material.

15. The acoustic barrier assembly of claim 14, wherein the material is assembled such that the first layer comprises an inside surface of the acoustic barrier assembly.

16. The acoustic barrier assembly of claim 14, wherein the material is assembled such that the fourth layer comprises an outside surface of the acoustic barrier assembly.

17. The acoustic barrier assembly of claim 14, wherein the first layer has a first width that is less than a second width of the second layer.

18. The acoustic barrier assembly of claim 15, wherein the first layer has a first width that is less than a second width of the second layer and less than a third width of the third layer and less than a fourth width of the fourth layer.

19. A method of assembling an acoustic barrier assembly, the method comprising the steps of:
obtaining a plurality of sheets of a material, the material including, but not limited to, a first layer comprising a first flexible material, the first flexible material configured to be impermeable to a lightweight gas, a second layer coupled with the first layer, the second layer comprising a second flexible material having less flexibility than the first layer, and a third layer coupled to one of the first layer and the second layer, the third layer comprising a third flexible material and further comprising an adhesive;
coupling the plurality of sheets of material together proximate a respective periphery of each sheet of material in a manner that forms a fluid-tight pocket and that leaves a portion of the plurality of sheets of material uncoupled to form an opening to the pocket, each sheet of material coupled together with each neighboring sheet of material via the third layer of each respective sheet;
inflating the acoustic barrier assembly by passing gas through the opening into the pocket; and
sealing the opening to retain the gas within the pocket.

20. The method of claim 19:
wherein the lightweight gas comprises helium,
wherein the adhesive comprises one of a heat activated adhesive, a chemical adhesive, and a pressure activated adhesive, and
wherein the method further comprises applying a vacuum to the opening to evacuate all matter from the pocket, and then introducing the helium into the pocket through the opening.
